(19) United States
(12) Patent Application Publication
(10) Pub. No.: US 2024/0165627 A1
(43) Pub. Date: May 23, 2024

(54) NON-CONTACT DISPENSER ASSEMBLIES AND RELATED SYSTEMS AND METHODS

(71) Applicant: ILLUMINA, INC., San Diego, CA (US)

(72) Inventors: Mikko Ponkala, San Francisco, CA (US); Paul Limb, San Mateo, CA (US); Reto Schoch, Danville, CA (US); Sonny Pham, San Jose, CA (US); Maulik Patel, San Diego, CA (US); Paul Crivelli, San Diego, CA (US)

(21) Appl. No.: 18/281,018

(22) PCT Filed: Mar. 17, 2022
(86) PCT No.: PCT/US2022/020735

§ 371 Date: Sep. 8, 2023

Related U.S. Application Data
(60) Provisional application No. 63/162,411, filed on Mar. 17, 2021.

(51) Int. Cl. B01L 3/00

(52) U.S. Cl. CPC B01L 3/527; B01L 2200/16; B01L 2300/0829; B01L 2300/18; B01L 2400/0487; B01L 2400/0638

(57) ABSTRACT

Non-contact dispenser assemblies and related systems and methods are disclosed. An implementation of an apparatus is disclosed that includes a reagent cartridge including a body defining a plurality of reservoirs. Each reservoir has an outlet and a distal end defining an opening, a manifold assembly including an outlet, a common fluidic line fluidly coupled to the outlet, a plurality of reagent fluidic lines coupled to the corresponding outlet of the reservoirs, and a plurality of membrane valves selectively fluidly coupling the common fluidic line and a corresponding one of the plurality of reagent fluidic lines.

### CROSS-REFERENCE TO RELATED APPLICATION

This application claims the benefit of and priority to U.S. Provisional Patent Application No. 63/162,411, filed Mar. 17, 2021, the content of which is incorporated by reference herein in its entirety and for all purposes.

### BACKGROUND

Various protocols in biological or chemical research involve performing controlled reactions. The designated reactions can then be observed or detected and subsequent analysis can help identify or reveal properties of chemicals involved in the reaction. In some multiplex assays, an unknown analyte having an identifiable label (e.g., a fluorescent label) can be exposed to thousands of known probes under controlled conditions. Each known probe can be deposited into a corresponding well of a microplate. Observing any chemical reactions that occur between the known probes and the unknown analyte within the wells can help identify or reveal properties of the analyte. Other examples of such protocols include known deoxyribonucleic acid (DNA) sequencing processes, such as sequencing-by-synthesis (SBS) or cyclic-array sequencing.

Some sequencing, such as DNA sequencing, may include moving reagents, buffers, and/or other materials through a flow channel of one or more flow cells, maintaining and/or modifying the temperature(s) of the materials within the flow channel, and illuminating fluorescent nucleotides within the flow channel. To use a shared pool of reagent resources for each flow cell may involve a fluidic solution that passes fluids to multiple flow cells either simultaneously or on demand.

### SUMMARY

Shortcomings of the prior art can be overcome and advantages and benefits as described later in this disclosure can be achieved through the provision of non-contact dispenser assemblies and related systems and methods. Various implementations of the apparatus and methods are described below, and the apparatus and methods, including and excluding the additional implementations enumerated below, in any combination (provided these combinations are not inconsistent), may overcome these shortcomings and achieve the advantages and benefits described herein.

In accordance with a first implementation, an apparatus is disclosed that includes a reagent cartridge, including a body defining a plurality of reservoirs containing reagent. Each reservoir has an outlet and a distal end defining an opening, and a manifold assembly including an outlet, a common fluidic line fluidly coupled to the outlet, a plurality of reagent fluidic lines fluidly coupled to the corresponding outlet of the reservoirs, and a plurality of membrane valves selectively actuatable to fluidly couple the common fluidic line and a corresponding one of the plurality of reagent fluidic lines and control a flow of reagent therebetween. The apparatus further includes a reagent cartridge receptacle to receive the reagent cartridge, a pressure source, a reagent cartridge interface having a pressure inlet fluidly coupled to the pressure source and a mating surface defining pressure outlets fluidly coupled to the pressure inlet, and a plate receptacle to receive a plate having a well. The mating surface of the reagent cartridge interface mates with the distal ends of the reservoirs and the pressure source pressurizes the corresponding reservoirs. A non-contact dispenser assembly includes the reagent cartridge, the reagent cartridge receptacle, and the reagent cartridge interface and is to dispense the reagent into the well of the plate.

In accordance with a second implementation, an apparatus is disclosed that includes a reagent cartridge including a body defining a plurality of reservoirs. Each reservoir has an outlet and a distal end defining an opening, a manifold assembly including an outlet, a common fluidic line fluidly coupled to the outlet, a plurality of reagent fluidic lines coupled to the corresponding outlet of the reservoirs, and a plurality of membrane valves selectively fluidly coupling the common fluidic line and a corresponding one of the plurality of reagent fluidic lines.

In accordance with a third implementation, an apparatus is disclosed that includes a reagent cartridge including a body having a top surface and a bottom surface, a top membrane coupled to the top surface of the body, a bottom membrane coupled to the bottom surface of the body, a plurality of reservoirs defined by the body, and a plurality of membrane valves. The membrane valves include a valve seat formed by the body. The reagent cartridge also includes a plurality of reagent fluidic lines formed in the bottom surface of the body. The reagent fluidic lines and the bottom membrane define reagent fluidic lines fluidly connecting the plurality of reservoirs to the plurality of membrane valves. The reagent cartridge also includes a common fluidic line formed in the top surface of the body. The common fluidic line and the top membrane define a common fluidic line having a distal end and an opposite, proximal end. Each of the plurality of valves is configured to fluidly connect one of the plurality of reservoirs to the common fluidic line to thereby dispense a reagent contained within the one of the plurality of reservoirs into the common fluidic line. The reagent cartridge also includes an outlet fluidly connected to the distal end of the common fluidic line and a cleaning fluid inlet fluidly connected to the proximal end of the common fluidic line.

In accordance with a fourth implementation, a method is disclosed that includes pressurizing a first reservoir of a reagent cartridge, actuating a first membrane valve of the reagent cartridge to fluidly connect the first reservoir to a common fluidic line of the reagent cartridge and dispense an amount of a first reagent into the common fluidic line from the first reservoir, actuating the first membrane valve to close a connection between the reservoir and the common fluidic line, actuating a cleaning fluid valve to dispense cleaning fluid into a proximal end of the common fluidic line to thereby dispense the first reagent from the common fluidic line through an outlet of the reagent cartridge fluidly connected to a distal end of the common fluidic line, pressurizing a second reservoir of the reagent cartridge, actuating a second membrane valve of the reagent cartridge to fluidly connect the second reservoir to the common fluidic line and dispense an amount of a second reagent into the common fluidic line from the second reservoir, actuating the second membrane valve to close a connection between the second reservoir and the common fluidic line, and actuating the cleaning fluid valve to dispense cleaning fluid into the proximal end of the common fluidic line to thereby dispense the second reagent from the common fluidic line through the outlet of the reagent cartridge.

In accordance with a fifth implementation, a method is disclosed that includes pressurizing a first reservoir of a reagent cartridge, actuating a first membrane valve of the reagent cartridge to fluidly connect the first reservoir to a common fluidic line of the reagent cartridge and dispense an amount of a first reagent into the common fluidic line from the first reservoir, dispensing a desired amount of the first reagent through an outlet of the reagent cartridge fluidly connected to a distal end of the common fluidic line, actuating the first membrane valve to close a connection between the reservoir and the common fluidic line, actuating a cleaning fluid valve to dispense cleaning fluid into a proximal end of the common fluidic line, pressurizing a second reservoir of the reagent cartridge, actuating a second membrane valve of the reagent cartridge to fluidly connect the second reservoir to the common fluidic line and dispense an amount of a second reagent into the common fluidic line from the second reservoir, actuating the second membrane valve to close a connection between the second reservoir and the common fluidic line, and actuating the cleaning fluid valve to dispense cleaning fluid into the proximal end of the common fluidic line to thereby dispense the second reagent from the common fluidic line through the outlet of the reagent cartridge.

In accordance with a sixth implementation, an apparatus includes a body defining a plurality of reservoirs and a manifold assembly. The manifold assembly includes a common fluidic line, a plurality of reagent fluidic lines coupled to the corresponding reservoir, and a plurality of valves selectively fluidly coupling the common fluidic line and a corresponding one of the plurality of reagent fluidic lines.

In further accordance with the foregoing first, second, third, fourth, and/or fifth implementations, an apparatus and/or method may further comprise or include any one or more of the following

In an implementation, the apparatus further includes a cleaning fluid reservoir. The reagent cartridge includes a cleaning fluid port fluidly coupled to the cleaning fluid reservoir and the common fluidic line.

In another implementation, the reagent cartridge interface includes a cleaning fluid conduit having a first end fluidly coupled with the cleaning fluid reservoir and a second end fluidly coupled with the cleaning fluid port of the reagent cartridge and an outlet conduit having a first end fluidly coupled with the outlet port of the reagent cartridge.

In another implementation, the reagent cartridge interface includes a plenum fluidly coupled with the pressure inlet and the pressure outlets.

In another implementation, the outlet of the reagent cartridge includes an outlet port. The reagent cartridge interface includes an outlet conduit having a first end fluidly coupled with the outlet port of the reagent cartridge and a second end through which the reagent is dispensed.

In another implementation, the apparatus further includes a valve that is selectively actuatable to control a flow of the reagent out of the outlet of the manifold assembly.

In another implementation, the apparatus further includes an elastomer coupled to the mating surface that mates with the distal ends of the reservoirs and forms a seal.

In another implementation, the pressure outlets pass through the elastomer.

In another implementation, the apparatus further includes a cover covering the distal ends of the reservoirs.

In another implementation, the pressure outlets include posts and the posts pierce the cover.

In another implementation, the reagent cartridge receptacle includes a pair of locating pins and the reagent cartridge has a corresponding pair of locating holes that receive the locating pins and align the reagent cartridge relative to the reagent cartridge receptacle.

In another implementation, one the locating holes has an elongated dimension to provide clearance when mounting the reagent cartridge to the reagent cartridge receptacle.

In another implementation, the apparatus further includes a temperature controller adjacent the reagent cartridge receptacle and positioned to control a temperature of the reagent cartridge.

In another implementation, the temperature controller includes a cooling plate having an inlet port to receive cooling fluid and an outlet port to dispense cooling fluid.

In another implementation, the temperature controller includes a thermoelectric cooler.

In another implementation, the apparatus further includes an actuator assembly to selectively actuate the membrane valves.

In another implementation, the actuator assembly includes a housing defining a mouth that receives a portion of the manifold assembly that includes the membrane valves.

In another implementation, the reagent cartridge includes opposing first and second membranes coupled to the body thereof. Each of the membrane valves has a valve seat and a valve member positioned between the opposing first and second membranes. At least one of the valve members is a cantilever having a distal end that is adapted to move the first membrane away from the corresponding valve seat of one of the plurality of membrane valves.

In another implementation, an actuator of the actuator assembly is to interface with both of the first and second membranes for a corresponding one of the plurality of membrane valves.

In another implementation, the actuator includes C-shaped members having an opening in which the portion of the manifold assembly is positioned.

In another implementation, the apparatus further includes springs carried by the housing of the actuator assembly. Each of the C-shaped members has a first leg and a second leg. The first leg is to urge the first membrane into engagement with the corresponding valve seat. The second leg is to urge the distal end of the cantilever into engagement with the first membrane to move the first membrane away from the corresponding valve seat.

In another implementation, the actuator of the system includes an indexed rod to move the first leg of the C-shaped member away from the valve seat and to move the second leg of the C-shaped member to urge the distal end of the cantilever into engagement with the first membrane to move the first membrane away from the corresponding valve seat.

In another implementation, the apparatus further includes a plurality of actuators carried by the reagent cartridge interface. Each actuator of the plurality of actuators corresponds to one of the plurality of membrane valves and is actuatable to selectively control a flow of reagent between each of the reagent fluidic lines and the common fluidic line.

In another implementation, the actuators include shape memory alloy actuators.

In another implementation, the reagent cartridge includes a secondary reagent reservoir, a secondary fluidic line, and a secondary outlet fluidly coupled to the secondary reagent reservoir by the secondary fluidic line.

In another implementation, the secondary outlet includes a secondary outlet port. The reagent cartridge interface includes a conduit having a first end fluidly coupled with the secondary outlet port and a second end through which reagent contained within the second reagent reservoir is dispensed.

In another implementation, the pressure inlet includes a first pressure inlet and a second pressure inlet and the pressure outlets include a first pressure outlet and a second pressure outlet. The first pressure inlet is fluidly coupled to the first pressure outlet and the second pressure inlet is fluidly coupled to the second pressure outlet.

In another implementation, the reagent cartridge interface includes a mixer to mix the reagent within the reservoirs.

In another implementation, the mixer includes mixing needles to be positioned within corresponding reservoirs.

In another implementation, the apparatus further includes a non-contact dispenser including the reagent cartridge.

In another implementation, the apparatus further includes a cover covering the distal ends of the reservoirs.

In another implementation, the cover includes an impermeable barrier.

In another implementation, the impermeable barrier includes foil.

In another implementation, the reagent cartridge includes opposing membranes coupled to the body thereof. The body defines a portion of the common fluidic line, a portion of the plurality of reagent fluidic lines, and a plurality of valve seats that each separate the common fluidic line and a corresponding one of the plurality of reagent fluidic lines.

In another implementation, the plurality of membrane valves further include a valve member. The valve member is movable to selectively fluidly couple the common fluidic line and a corresponding one of the plurality of reagent fluidic lines responsive to actuation thereof.

In another implementation, at least one of the valve members is a cantilever having a distal end that is adapted to move one of the opposing membranes away from a corresponding valve seat of one of the plurality of membrane valves.

In another implementation, the valve members are positioned between the opposing membranes.

In another implementation, the apparatus further includes a valve positioned between the outlet and the membrane valves and to control a flow of the reagent out of the outlet.

In another implementation, the plurality of membrane valves include volcano valves.

In another implementation, the plurality of membrane valves include rod-flap valves.

In another implementation, the plurality of reservoirs have two or more different volume sizes.

In another implementation, the reagent cartridge further includes a secondary reservoir and a secondary outlet fluidly connected to the secondary reservoir.

In another implementation, the body defines a plurality of locating openings therein to provide registration of the reagent cartridge during installation.

In another implementation, the reagent cartridge further includes an impermeable barrier extending over the plurality of reservoirs. The apparatus also includes a reagent cartridge interface including an interior plenum, a pressure inlet to fluidly connect a positive pressure source to the interior plenum, and a plurality of pressure outlets fluidly connected to the interior plenum. The plurality of pressure outlets to puncture the impermeable barrier to supply positive pressure to the plurality of reservoirs when the reagent cartridge interface is mounted to the reagent cartridge.

In another implementation, the interior plenum includes a plurality of interior plenums and the pressure inlet includes a plurality of pressure ports corresponding to the plurality of interior plenums.

In another implementation, the reagent cartridge interface further includes a mixing needle to extend into one of the plurality of reservoirs. The mixing needle to provide a cycle of negative and positive pressure to the one of the plurality of reservoirs to mix materials therein.

In another implementation, the outlet includes an outlet port and the cleaning fluid inlet includes a cleaning fluid port. The outlet port and the cleaning fluid port are defined by upstanding annular walls of the body. The reagent cartridge interface includes conduits having an end with an o-ring captured therearound and sized to sealingly fit within the annular walls when the reagent cartridge interface is mounted to the reagent cartridge.

In another implementation, the apparatus further includes a plurality of actuators configured to selectively engage and actuate the plurality of membrane valves.

In another implementation, the plurality of membrane valves are pressurized to deflect the top membrane from the valve seat. The plurality of actuators hold the top membrane against the valve seat to hold the plurality of valves in a closed position.

In another implementation, the plurality of membrane valves include a movable valve member. The plurality of actuators to drive the movable valve members upward to deflect the top membrane from the valve seat.

In another implementation, the plurality of actuators includes a plurality of C-shaped members biased to hold the plurality of membrane valves in a closed position by an upper portion of the plurality of C-shaped members holding the top membrane against the valve seats of the plurality of membrane valves. The apparatus includes an indexed rod configured to sequentially drive the plurality of C-shaped members upward to disengage the upper portion from the top membrane and to drive a lower portion of the plurality of C-shaped members into the valve members to move the valve members upward to deflect the top membrane from the valve seat to thereby selectively open the plurality of membrane valves.

In another implementation, the plurality of actuators include shape memory alloy actuators.

In another implementation, the distal end of the common fluidic line further includes an anvil with an associated recess extending therearound to collect reagent therein. The top membrane extends over the recess. The apparatus includes a piezo hammer configured to impact the anvil through the top membrane to dispense droplets through the outlet.

In another implementation, the distal end of the common fluidic line further includes an outlet valve including a valve seat, a movable valve member, and the top and bottom membranes. The apparatus includes a biasing member to engage one of the top and bottom membranes to hold the one of the top and bottom membranes against the valve seat and an actuator to selectively move the valve member to move the one of the top and bottom membranes away from the valve seat against the force of the biasing member to thereby open the outlet valve.

In another implementation, the apparatus further includes a solenoid valve fluidly connected to the outlet of the common fluidic line to selectively dispense a desired amount of fluid.

In another implementation, the reagent cartridge further includes a dispensing tip fluidly coupled to the outlet and depending from the body.

In another implementation, the apparatus further includes an air supply fluidly connected to the cleaning fluid port and configured to introduce air bubbles in the common fluidic line between a reagent and cleaning fluid.

In another implementation, the apparatus further includes an optical sensor mounted adjacent to an outlet of the system and configured to identify the air bubbles being dispensed through the outlet.

In another implementation, the apparatus further includes a cooling plate. The cooling plate includes a dock for the reagent cartridge to mount thereto.

In another implementation, the method also includes detecting liquid dispensed through the outlet of the reagent cartridge with an optical sensor.

In another implementation, the method also includes actuating a gas valve to introduce a gas bubble into the common fluidic line upstream of the first reagent.

In another implementation, the method further includes determining that the first reagent is fully dispensed by identifying a break in fluid due to the gas bubble with an optical sensor.

In another implementation, actuating the cleaning fluid valve to dispense cleaning fluid into the proximal end of the common fluidic line comprises dispensing cleaning fluid into the proximal end of the common fluidic line until a break in fluid being dispensed through the outlet of the reagent cartridge due to the gas bubble is detected by an optical sensor.

In another implementation, the method further includes actuating the gas valve to introduce gas into the common fluidic line until a break in fluid is detected by the optical sensor to reset the common fluidic line for a subsequent reagent.

In another implementation, pressurizing the first reservoir and the second reservoir of the reagent cartridge includes supplying a positive pressure to the first reservoir and the second reservoir from pressure outlets of a reagent cartridge interface having a body defining a plenum therein when the reagent cartridge interface is mounted to the reagent cartridge.

In another implementation, the method further includes closing an outlet valve fluidly connected to the outlet to prevent fluid flow therethrough, opening the first membrane valve to fluidly connect the first reservoir to the common fluidic line, and dispensing rehydrating fluid into the proximal end of the common fluidic line and into the first reservoir through the first membrane valve to thereby rehydrate a reagent within the first reservoir.

In another implementation, the method further includes mixing the rehydrating fluid and the reagent by repeatedly cycling between a positive pressure source and a negative pressure source fluidly connected to the first reservoir through a mixing needle inserted therein.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is an exploded perspective view of a first non-contact dispenser assembly that can be used in the system of FIG. 1.

FIG. 3 is a top perspective view of a reagent cartridge for the non-contact dispenser assembly of FIG. 2.

FIG. 4 is a bottom perspective view of the reagent cartridge for the non-contact dispenser assembly of FIG. 2.

FIG. 5 is a cross-sectional view of the reagent cartridge interface and the cooling plate for the non-contact dispenser assembly of FIG. 2.

FIG. 6 is a bottom perspective view of the reagent cartridge interface for the non-contact dispenser assembly of FIG. 2.

FIG. 7 is a cross-sectional view of a portion of a manifold assembly including a membrane valve for the reagent cartridge of FIG. 3.

FIG. 8 is a bottom perspective view of the reagent cartridge of FIG. 3 and an actuator assembly for the non-contact dispenser assembly of FIG. 2.

FIG. 9 is a cross-sectional schematic view of an actuator assembly of FIG. 8 with one of the C-shaped members of an actuator in a closed position.

FIG. 10 is a cross-sectional schematic view of the actuator assembly of FIG. 8 with the C-shaped member of the actuator in an open position.

FIG. 11 is a perspective view of a second implementation of a non-contact dispenser assembly that can be used with the system of FIG. 1.

FIG. 12 is a top plan view of a reagent cartridge for the non-contact dispenser assembly of FIG. 11.

FIG. 13 is a bottom perspective view of the reagent cartridge for the non-contact dispenser assembly of FIG. 11.

FIG. 14 is a top perspective view of the reagent cartridge interface and the reagent cartridge receptacle for the non-contact dispenser assembly of FIG. 11.

FIG. 15 is a bottom perspective view of the reagent cartridge interface for the non-contact dispenser assembly of FIG. 11.

FIG. 16 is a cross-sectional view of the reagent cartridge of FIG. 12 and the reagent cartridge interface of FIG. 14.

FIG. 17 is a cross-sectional view of a portion of a manifold assembly including a membrane valve for the reagent cartridge of FIG. 12.

FIG. 18 is a top perspective partial cross-sectional view of a non-contact dispenser assembly with a second reagent cartridge interface that can be used to implement the non-contact dispenser assembly and the reagent cartridge interface of FIG. 1.

FIG. 19 is another cross-sectional view of the non-contact dispenser assembly of FIG. 18.

FIG. 20 depicts a flow-process diagram of processes of using a system that can be used to implement the system of FIG. 1 and/or any of the non-contact dispensing assemblies.

FIG. 21 depicts a flow-process diagram of processes of using a system that can be used to implement the system of FIG. 1 and/or any of the non-contact dispensing assemblies.

FIG. 22 is a top perspective view of a reagent cartridge including an outlet valve that can be used in the system of FIG. 1.

FIG. 23 is a top perspective view of a reagent cartridge including the outlet valve in another orientation that can be used in the system of FIG. 1.

FIG. 24 is a top perspective view of another reagent cartridge including an outlet valve that can be used in the system of FIG. 1.

FIG. 25 is a cross-sectional detailed view of the reagent cartridge of FIG. 24 showing the outlet valve.

FIG. 26 illustrates a flowchart for a first method of using the system of FIG. 1 or any of the implementations disclosed.

FIG. 27 illustrates a flowchart for a second method of using the system of FIG. 1 or any of the implementations disclosed.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative examples would still fall within the scope of the claims.

For reagent delivery in an automated library preparation platform it is important to be able to contain certain reagents in a compact cartridge that minimizes dead volume. Furthermore, the cartridge may involve selecting individually which reagent is being supplied.

Current on market technologies do not address the need for compact reagent storage close to the dispensing mechanism to eliminate dead volumes. Aspiration based technologies may enable designing custom reagent cartridges that pipettors aspirate from, but upon dispensing the pipette tip makes contact with the reaction, thereby requiring a new consumable for each aspiration/dispensing step generating large quantities of waste. Other technologies are able to aspirate from a single reagent source and dispense via a non-contact method reducing the required consumables by using the same dispensing consumable for multiple reactions. However, the same consumable cannot be shared across multiple reagents since each consumable has a discrete aspiration reservoir making the platform either very large or requiring many consumable change outs throughout the workflow if many different reagents are used over the course of the workflow. Additionally, if the reagents are thermally controlled, a large dead volume may be involved since the reagents may be recirculated from another vessel which provides the thermal conditioning. Other non-contact dispensers dispense reagent from pressurized prefilled consumables. However, only one reagent may feed into each dispenser increasing the number of consumables. Additionally, the reagents may be stored off to the side of the instrument requiring a long tube to connect to the dispensing valve increasing the reagent dead volume. Increased reagent dead volume may increase associated costs due to the wasted reagents. Other dispensers may only provide a means for dispensing, but no integrated reagent storage solution.

The methods, systems, apparatus, and/or device disclosed herein may address the challenges noted above. The reagent is dispensed via a contactless method reducing the number of consumables. Additionally, the integrated valving on the reagent storage cartridge feeding the contactless dispensing valve allows feeding multiple reagents into a single dispensing valve reducing the number of dispensers. The compact design and valve integration on the cartridge enables mounting it directly onto the dispensing valve eliminating long tubing runs and reducing the dead volume. The reagent path on the cartridge may be fully sealed allowing for reuse of many if not all actuators from one workflow to the next. Only the reagent cartridge may need to be changed out to refill the reagents for the next workflow to start. Alternatively, the cartridge may store reagent to support multiple workflows which is facilitated by rinsing the common line in between workflows to prevent residue build up.

In some examples, a dispensing mechanism may be incorporated onto the same cartridge as the reagent reservoir and reagent selection valves. The dispensing mechanism may be a flexible membrane which when disturbed by an external force such as a piezo actuator dispenses the reagent by squeezing the reagent channel. The membrane which is struck to dispense the reagent may be forced shut by a passive control mechanism such as a spring. In such an implementation, the dispense mechanism valve is opened when forced by the actuator, but immediately shut by the passive closing force as the actuator is de-energized. Such a normally closed integrated dispensing mechanism allows for pressurizing the cartridge and for potentially higher reagent flow rates.

In some examples, an apparatus includes a reagent cartridge, a valve actuation mechanism, a process connection header, and an environmental conditioning nest.

A reagent cartridge may integrate reservoirs for holding fluids as well as valve bodies for reservoir selection onto one component. The reservoirs may be of varying sizes to accommodate different required volumes based on reagent type used throughout a particular workflow. The valves may be flap type valves that may utilize actuation force to keep them closed with reagent pressure providing the opening force. Alternatively, the valves may be actively controlled for both opening and closing. The valves tie, in some examples, directly into the common supply header reducing dead volume and removing any dead legs in the common fluid path rendering it, at least in part, easier for cleaning. The furthest most valve from the header outlet is used as the cleaning port through which a cleaning fluid (such as a wash or cleaning reagent) may be supplied. Additionally, the cleaning fluid may be used as a pressure source in a pressurized fluid system. In such set up the common line is filled with the reagent of interest by opening the flap valve and pressurizing the reagent reservoir. After the common line is filled, the reagent valve is shut and the cleaning valve opened and the cleaning fluid reservoir pressurized. During the dispense to target vessel, the common line is then backfilled with the cleaning fluid. This approach has several advantages, the fluidic path during dispensing to target vessel is always the same regardless of which reagent is being dispensed increasing the dispensing accuracy. Additionally, the common line is being flushed during the dispense itself enabling faster switching between reagents. The cleaning fluid does not have to be stored on the cartridge itself, but may be supplied from a larger reservoir. Upstream of the cleaning fluid port, a selector valve may be placed on the instrument to enable selecting between a liquid or gas to fill the common line if desired. The outlet of the common header supplies one or more dispensing valves that determine the amount dispensed into the reactions. The cartridge may also contain reservoirs for reagents not tied to the same common line. Such design includes multiple outlet ports equal to the number of common lines and individual reservoirs on the cartridge. The cartridge itself may be composed of three components: a body, and top membranes, and bottom membranes. Each subcomponent can be injection molded for low cost manufacturing. The body makes up the reservoirs holding the reagents, the fluidic pathways, and the valve flaps. The top and bottom membranes seal the fluidic pathways and the valves bodies. The cartridge can be filled at a manufacturing facility and sealed with foil encapsulating the reagents.

A valve actuating mechanism may control which reagent from the reservoirs on the cartridge is flowing through the outlet port into the dispensing valve. The mechanism may actively control both open and closing of the valves or just one of the two. Each valve may be opened and closed individually. When controlling both opening and closing of the valve, the actuator provides a force to open the valve when the valve is opened and a force to close the valve when the valve is shut off. When supplying a closing force and not an opening force, the actuator does not provide force on the valve when the valve is turned on, and fluidic pressure provides the necessary force to open the valve. When the valve is closed, the actuator force overcomes the fluidic pressure, and seals or at least substantially seals the valve shut. If providing an opening force and not a closing force, the actuator provides a force to open the valve turning it on. When closing or when closed, the valve does not provide any force and the valve is shut off by a spring or similar passive source sealing or at least substantially sealing the valve shut. The actuation mechanism could include a shape memory alloy (SMA) actuator, a pneumatic piston, or an indexed rod with motor similar to a cam shaft which opens and closes different valves when rotated. In the configuration with an indexed shaft, springs may be used to provide closing pressure to the flap valves while not being forced open by the indexed shaft. Alternatively, these c-shaped actuators may be energized by SMA actuators or solenoid pins to enable greater control over which valves is opened.

A process connection header may dock or otherwise mate onto the cartridge. During the docking or mating process, the process connection header may pierce a foil of the cartridge and create one or more seals on the top surface of the reagent reservoirs. The header provides pressurized air to each reservoir which allows each reagent to be supplied out of the cartridge. Alternatively, the header may contain another port that may be used for rehydrating lyophilized reagents and/or mixing rehydrated reagents. The additional port may also be utilized for keeping solid particles such as magnetic beads resuspended within the reservoir. The header may be a single common plenum providing the same pressure into each well or included valving to individually regulate pressure into each reservoir. Additionally, the header may have a connection to a cleaning fluid (such as a wash or cleaning reagent) which may be used to rinse out the common fluidic header in the cartridge when changing between reagents. Another connection on the header may be an outlet of the reagent cartridge which provides a fluidic pathway to the dispensing valve.

An environmental condition nest on which the cartridge sits may control the temperature of the reagent cartridge. The temperature control may be achieved by a number of different devices, apparatuses, and/or methods, such as a fluidic heat exchanger, an electronic cooling solution such as a peltier stage, or may be well insulated against the environment and contain a passive heated or cooled block which can be placed inside to condition the reagents for the duration of the workflow.

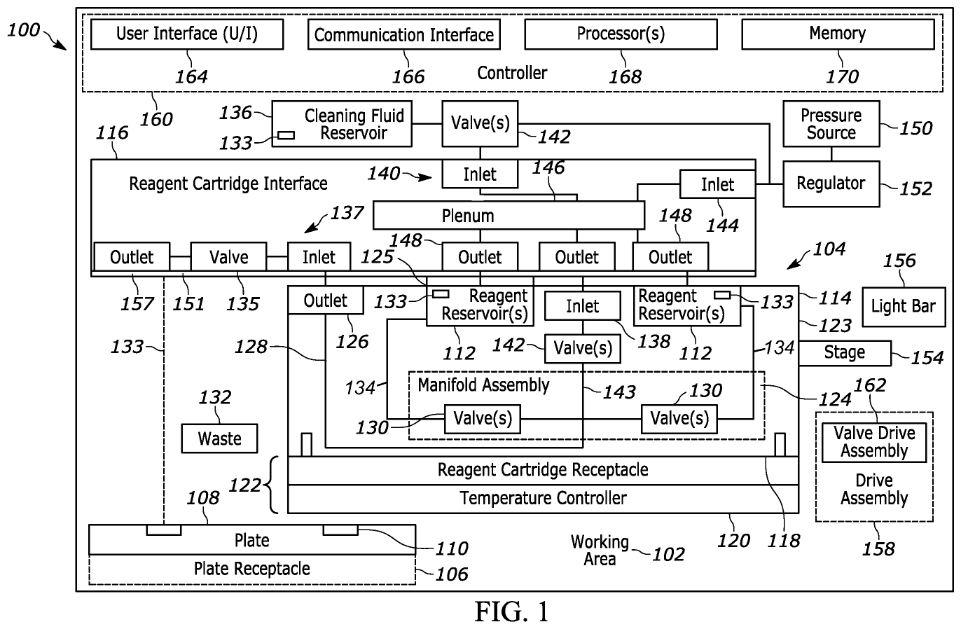

FIG. 1 illustrates a schematic diagram of an implementation of a system 100 in accordance with the teachings of this disclosure. The system 100 may can be used to automatically, easily, and efficiently prepare DNA libraries for sequencing applications, for example. The system 100 may perform DNA library preparation workflows that include amplification processes, cleanup processes, library normalization processes, and/or pooling processes in some implementations. The system 100 may perform workflows such as whole genome sequencing (WGS) workflows, DNA & RNA enrichment workflows, methylation workflows, split-pool amplicon workflows, and/or amplicon workflows. The DNA library preparation workflow can be performed on any number of samples such as between one sample, twenty four samples, forty eight samples, ninety six samples. The system 100 thus allows for variable batch processing. Other uses of the system 100 may prove suitable, however. The system 100 includes a working area 102 and a non-contact dispenser assembly 104. The non-contact dispenser assembly 104 may alternatively be positioned above the working area 102.

The working area 102 includes a plate receptacle 106 that receives a plate 108 having a well 110. The working area 102 may alternatively include any number of plate receptacles such as four plate receptacles, eight plate receptacles, eleven plate receptacles. The non-contact reagent dispenser assembly 104 dispenses reagent from reagent reservoirs 112 into the well 110 of the plate 108. The plate 108 may have any number of wells 110, such as 24 wells. Another number of wells 110 is suitable, however, such as 48 wells, 96 wells.

The non-contact dispenser assembly 104 includes a reagent cartridge 114, a reagent cartridge interface 116, a reagent cartridge receptacle 118, and a temperature controller 120. The system 100 includes the reagent cartridge interface 116, the reagent cartridge receptacle 118, and the temperature controller 120. The reagent cartridge 114 is a consumable that is received by the system 100 in the implementation shown and, thus, may be disposed of after a workflow is complete. Each reagent cartridge 114 may contain and be used to dispense reagent for a particular workflow. Cross contamination is reduced using the reagent cartridges 114 disclosed that are part of the non-contact dispenser assembly 104. The system 100 can easily perform and change between different workflows as a result based on the reagent cartridge 114 received. The reagent cartridge receptacle 118 and the temperature controller 120 may be combined into a single component or may be separate components. The temperature controller 120 can take any suitable form, including, a fluidic heat exchanger, a cooling plate, an electronic cooling solution such as a peltier stage, being well insulated against the environment and containing a passive heated or cooled block which can be placed inside to condition the reagents for the duration of the workflow. The temperature controller 120 may alternatively be a temperature controlled chamber that controls the temperature of the reagent cartridge 114 and in which the reagent cartridge 114 is positioned. The reagent cartridge receptacle 118 and the temperature controller 120 can be combined into an environmental nest 122 including the functionality of both components.

The reagent cartridge 114 includes a body 123 defining the reagent reservoirs 112 and a manifold assembly 124 in the implementation shown. The reagent reservoirs 112 have distal ends 125 and the manifold assembly 124 includes an outlet 126, a common fluidic line 128 fluidly coupled to the outlet 126, two or more membrane valves 130, and reagent fluidic lines 134 fluidly coupling the reagent reservoirs 112 to the membrane valves 130. The membrane valves 130 are selectively actuatable to fluidly couple the common fluidic line 128 and a corresponding one of the reagent fluidic lines 134 and control a flow of reagent therebetween. The valves of the system 100 may be implemented by a rotary valve, a selector valve, a pinch valve, a flat valve, a solenoid valve, a check valve, a piezo valve, a membrane valve, a volcano valve, a rod-flap valve, etc. Other fluid control devices may prove suitable.

The reagent reservoirs 112 may contain reagent 133. One or more of the reagent reservoirs 112 may contain the same reagent 133 or a different reagent 133. One of the reagent reservoirs 112 may, thus, contain a first reagent and another one of the reagent reservoirs 112 may contain a second reagent. The reagent 133 may be liquid reagent and/or lyophilized reagent. The reagent 133 may be rehydrated prior to use in implementations when the reagent 133 is a lyophilized reagent.

The system 100 includes a waste reservoir 132 and the reagent cartridge interface 116 includes an outlet valve 135 fluidly coupled to the outlet 126 of the reagent cartridge 114. The non-contact dispenser assembly 104 may dispense fluid into the waste reservoir 132 during different processes of a workflow.

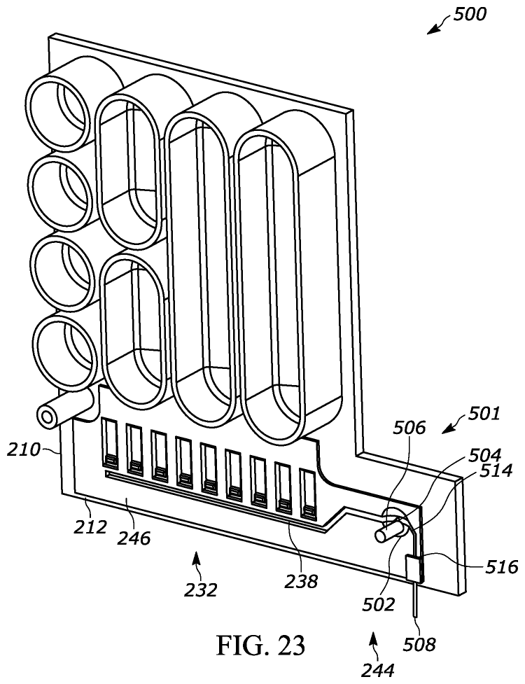

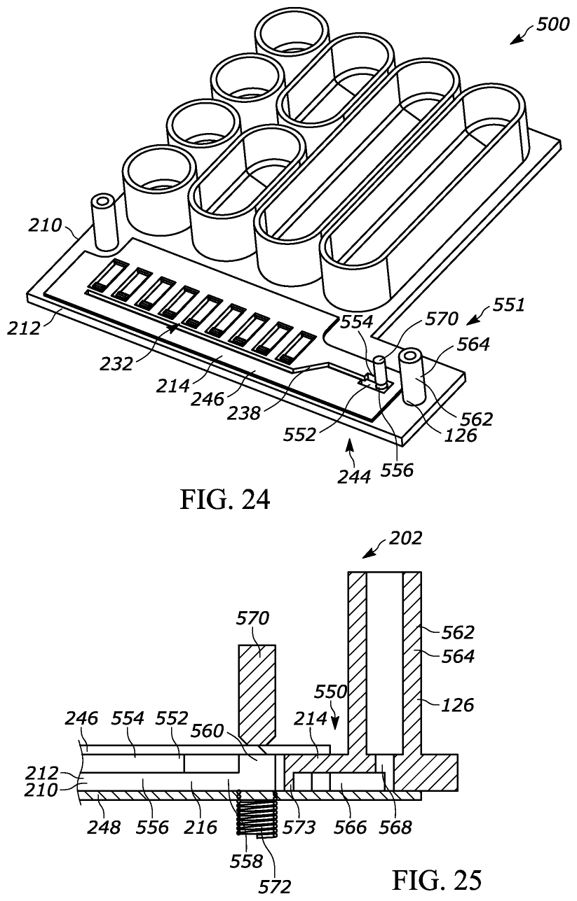

The reagent cartridge interface 116 includes a supply line 137, including an inlet and an outlet, fluidly coupled to the outlet 126 of the reagent cartridge 114 to receive fluid flow from the reagent cartridge 114. The supply line 137 may be referred to as an outlet conduit. The outlet valve 135 is positioned along the supply line 137 and controls flow of fluid through the supply line 137. The outlet valve 135 can alternatively be carried by the reagent cartridge 114 as shown in FIGS. 23 and 24. The reagent cartridge 114 having the outlet valve 135 may dispense fluid into the well 110 or the waste reservoir 132 in such implementations and the outlet valve 135 and the supply line 137 on the reagent cartridge interface 116 may be omitted. The outlet valve 135 may thus be part of the reagent cartridge 114 in such an implementation and implemented as a solenoid valve fluidly coupled to the outlet 126 to selectively dispense a desired amount of fluid. The outlet valve 135 may be implemented as a different type of valve and/or may be coupled to an outlet of the common fluidic line 128.

The non-contact dispenser assembly 104 further includes a cleaning fluid reservoir 136 in the implementation shown and the reagent cartridge 114 includes a corresponding inlet or port 138 fluidly connected to the cleaning fluid reservoir 136 by a supply line or conduit 140 including an inlet and an outlet. The port 138 may be referred to as a cleaning fluid port and the conduit 140 may be referred to as a cleaning fluid conduit. In one implementation, the conduit 140 can be a portion of the cartridge reagent interface 116. A cleaning fluid valve 142 can be coupled to the conduit 140 to control fluid flow therethrough. The cleaning fluid port 138 is fluidly connected to the common fluidic line 134 by a cleaning fluid line 143. The cleaning fluid reservoir 136 includes a fluid 153 in the implementation shown. The fluid 153 may be a cleaning fluid and/or a rehydrating fluid. The cleaning fluid may be a wash buffer.

The fluid 153 may additionally or alternatively be used to rehydrate the reagent 133 in the reservoir 112. The valve 135 of the reagent cartridge interface 116 is closed to rehydrate the reagent 133 and the valves 130, 142 are opened to flow the fluid 153 from the cleaning fluid reservoir 136 to the reagent reservoir 133 and to rehydrate the reagent 133. The system 100 may include a mixer to mix the reagent 133 and the fluid 153, for example.

The reagent cartridge interface 116 pressurizes the reagent reservoirs 112 of the reagent cartridge 114 in operation when coupled thereto. Pursuant to this, the reagent cartridge interface 116 includes a pressure inlet 144, one or more interior chambers defining a plenum 146, and pressure outlets 148 for each of the reagent reservoirs 112. The plenum 146 is fluidly coupled to the pressure inlet 144 and the pressure outlets 148 and may be referred to as an interior plenum. A pressure source 150 is fluidly coupled to the pressure inlet 144 to pressurize the plenum 146 and the reagent reservoirs 112 therethrough. The pressure source 150 may be referred to as a positive pressure source. The pressure source 150 may be referred to as an air supply. The pressure source 150 is also shown in this implementation fluidly coupled to the cleaning fluid valve 142. The cleaning fluid valve 142 may be a selector valve that can be actuated to allow the pressure source 150 to selectively flow gas into the common fluidic line 128. The pressure source 150 can introduce air bubbles into the common fluidic line 128 as a result.

The reagent cartridge interface 116 also has a mating surface 151 that defines the pressure outlets 148. The mating surface 151 of the reagent cartridge interface 116 mates with the distal ends 125 of the reservoirs 112 in operation and the pressure source 150 pressurizes the corresponding reservoirs 112. An elastomer 157 is coupled to the mating surface 151 in the implementation shown and mates with the distal ends 125 of the reservoirs 112 in operation and forms a seal. The pressure outlets 148 are shown passing through the elastomer 157. If desired, the system 100 can include a pressure regulator 152 to control the supply of pressure.

In one implementation, the working area 102 includes a stage 154 that is used to move the reagent cartridge 114, the reagent cartridge interface 116, the reagent cartridge receptacle 118, and the temperature controller 120 relative to the plate receptacle 106. The stage 154 may be an X-Y stage or an X-Y-Z stage. In another implementation, a stage may be provided that moves the plate receptacle 118 in the X, Y, and/or Z axes to facilitate dispensing into the plate receptacle 118. A light bar 156 is also shown being included that may be used to degrade oligonucleotides. The light bar 156 may be a high power ultraviolet light (UV) light bar that is regularly used throughout a workflow to repeatedly degrade oligonucleotides to deter cross contamination in some implementations. The light bar 156 may alternatively be omitted.

The system 100 also includes a drive assembly 158 and a controller 160. The controller 160 is electrically and/or communicatively coupled to the components of the system 100 to perform various functions as disclosed herein. The drive assembly 158 includes a valve drive assembly 162. The valve drive assembly 162 may be adapted to interface with the valves of the system 100 to control the position and configuration of the valves.

The controller 160 includes a user interface 164, a communication interface 166, one or more processors 168, and a memory 170 storing instructions executable by the one or more processors 168 to perform various functions including the disclosed implementations. The user interface 164, the communication interface 166, and the memory 170 are electrically and/or communicatively coupled to the one or more processors 168.

In an implementation, the user interface 164 receives input from a user and provides information to the user associated with the operation of the system 100 and/or an analysis taking place. The user interface 164 may include a touch screen, a display, a key board, a speaker(s), a mouse, a track ball, and/or a voice recognition system. The touch screen and/or the display may display a graphical user interface (GUI).

In an implementation, the communication interface 166 enables communication between the system 100 and a remote system(s) (e.g., computers) using a network(s). The network(s) may include an intranet, a local-area network (LAN), a wide-area network (WAN), the intranet, etc. Some of the communications provided to the remote system may be associated with a dispensing process(es), an amplification process(es), a cleanup process(es), a library normalization process(es), and/or a pooling process(es)), etc. generated or otherwise obtained by the system 100. Some of the communications provided to the system 100 may be associated with a dispensing process(es), an amplification process(es), a cleanup process(es), a library normalization process(es), and/or a pooling process(es) to be executed by the system 100.

The one or more processors 168 and/or the system 100 may include one or more of a processor-based system(s) or a microprocessor-based system(s). In some implementations, the one or more processors 168 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 170 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

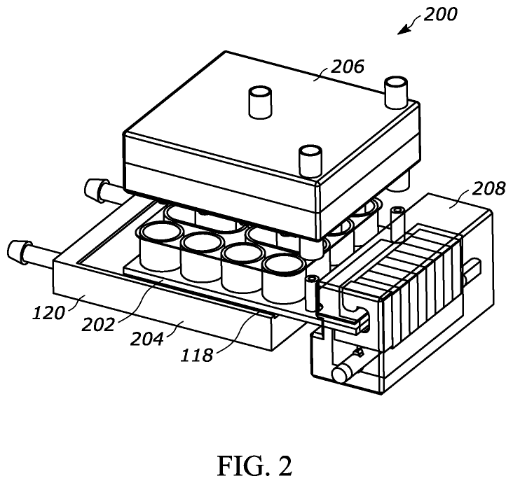

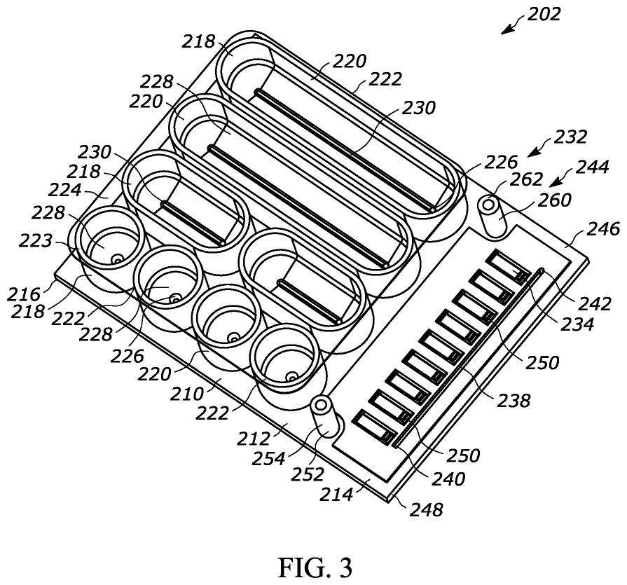

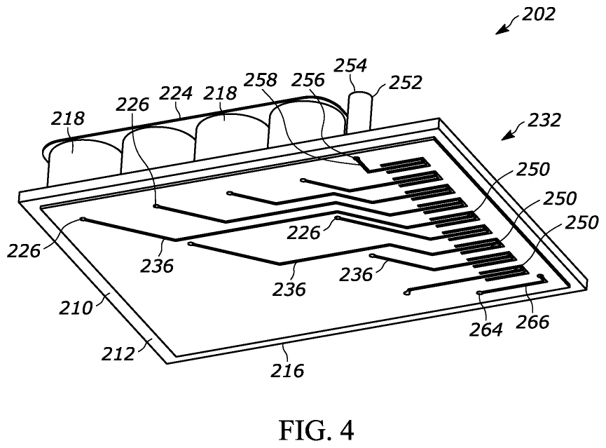

FIG. 2 is an exploded perspective view of a first implementation of a non-contact dispenser assembly 200 that can be used to implement the non-contact dispenser assembly 104 of FIG. 1. The non-contact dispenser assembly 200 includes a reagent cartridge 202 that can be used to implement the reagent cartridge 114 of FIG. 1, a cooling plate 204 that can be used to implement the reagent cartridge receptacle 118 and the temperature controller 120 of FIG. 1, and a reagent cartridge interface 206 that can be used to implement the reagent cartridge interface 116 of FIG. 1. The cooling plate 204 may be referred to as an environmental nest. The reagent cartridge interface 206 may alternatively be referred to as a header. An actuator assembly 208 that can be used to implement the valve drive assembly 162 of FIG. 1 is also shown. Details of the reagent cartridge 202 are shown in FIGS. 3 and 4.

FIG. 3 is a top perspective view of the reagent cartridge 202 of FIG. 2. The reagent cartridge 202 includes a body 210 having a base portion 212 with top and bottom surfaces 214, 216. The body 210 further includes a plurality of reservoirs 218 defined by walls 220 extending upwardly from the base portion 212 to distal ends 222 that define an open top 223. The reagent cartridge 202 can be provided with a cover 224 that extends over the open tops 223 of the reservoirs 218 and seals to the distal ends 222 of the walls 220 to thereby seal each of the reservoirs 218 to safely contain reagents disposed therein for storage and transportation purposes. The cover 224 can be made of any suitable material to provide an impermeable barrier, such as foil, plastic, etc.

Each of the reservoirs 218 further include an outlet 226 extending through the base portion 212 to open at the bottom surface 216 thereof. A bottom surface 228 of each the reservoirs 218 can be angled or otherwise contoured to direct fluid flow to the outlet 226 thereof. For example, a reservoir 218 having a circular horizontal cross-section can have a frusto-conical bottom surface 228, while an expanded, track-shaped reservoir 218 can have half frusto-conical portions on ends thereof connected by side angled surfaces leading to a drainage line 230 leading to the outlet 226.

As shown, the reservoirs 218 can be provided in any suitable combination of volumes. For example, the reagent cartridge 202 can include reservoirs 218 of all the same size, two differently sized reservoirs 218, three differently sized reservoirs 218, four differently sized reservoirs 218, and so forth. In the implementation shown, the distal ends 222 of the walls 220 of the reservoirs 218 are disposed within a common plane to provide a convenient engagement surface for the cover 224 and other components of the system, as discussed in more detail below. As such, the walls 220 of the reservoirs 218 can have larger or smaller horizontal dimensions relative to one another to provide reservoirs 218 of desired differing volumes. Any desired number of reservoirs 218 can be provided on the reagent cartridge 202, however, and all of the reservoirs 218 need not be filled with a reagent if fewer reagents are needed for a particular process. For example, the illustrated reagent cartridge 202 includes a row of four reservoirs, a row of two reservoirs.

The reagent cartridge 202 includes a manifold assembly 232 that can be used to selectively dispense reagents stored within the reservoirs 218 from the reagent cartridge 202. The manifold assembly 232 further includes valve bodies 234 defined in the base portion 212 for each of the reservoirs 218 and reagent fluidic lines 236 (see, FIG. 4) defined in the bottom surface 216 of the base portion 212 to fluidly connect the outlets 226 of the reservoirs 218 to the respective valve body 234.

A common fluidic line 238 for the manifold assembly 232 extends adjacent to the valve bodies 234. The common fluidic line 238 is defined in the top surface 214 of the body base portion 212 and has a proximal end 240 and an opposite, distal end 242 fluidly connected to a cartridge outlet 244, with the valve bodies 234 disposed adjacent to the common fluidic line 238 between the proximal and distal ends 240, 242 thereof.

As shown, the reagent cartridge 202 further includes a top membrane 246 that is coupled to the top surface 214 of the body base portion 212 and a bottom membrane 248 that is coupled to the bottom surface 216 of the body base portion 212. The top and bottom membranes 246, 248 interact with the valve bodies 234 to form membrane valves 250 corresponding to each of the reservoirs 218. The top membrane 246 extends over and seals the common fluidic line 238 and the bottom membrane 248 extends over and seals the reagent fluidic lines 236.

The body 210 further defines a cleaning port or reservoir 252 defined by walls 254 extending upwardly from the base portion 212. An outlet 256 (see, FIG. 4) of the cleaning port 252 that extends into or through the body 210 is fluidly connected to the proximal end 240 of the common fluidic line 238. In one implementation, the outlet 256 of the cleaning port 252 can be connected to the common fluidic line 238 by a cleaning line 258 (see, FIG. 4) defined in the body bottom surface 216 and sealed by the bottom membrane 248. Alternatively, the cleaning line 258 could be defined in the body top surface 214 and sealed by the top membrane 246.

In the implementation shown, the cartridge outlet 244 includes an outlet port 260 defined by walls 262 extending upwardly from the base portion 212. An inlet opening 264 of the outlet port 260 extending into or through the body 210 is fluidly connected to the distal end 242 of the common fluidic line 238. In one implementation, the inlet opening 264 of the outlet port 260 can be connected to the common fluidic line 238 by an outlet line 266 defined in the body bottom surface 216 and sealed by the bottom membrane 248. Alternatively, the outlet line 266 could be defined in the body top surface 214 and sealed by the top membrane 246.

FIG. 4 is a bottom perspective view of the reagent cartridge 202 for the non-contact dispenser assembly 200 of FIG. 2. The body bottom surface 216 of the reagent cartridge 202 as shown includes the outlets 226 of the reservoirs 218, the reagent fluidic lines 236, the outlet 256 of the cleaning port 252, the cleaning line 258, portions of the membrane valves 250, the inlet opening 264 of the outlet port 260, and the outlet line 266.

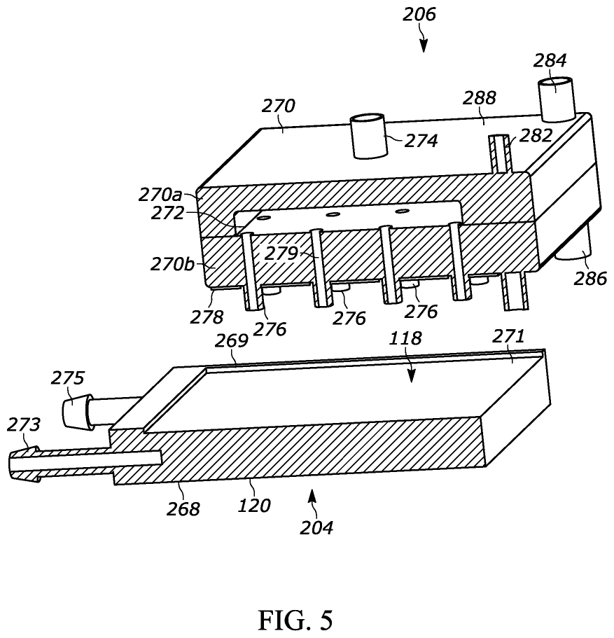

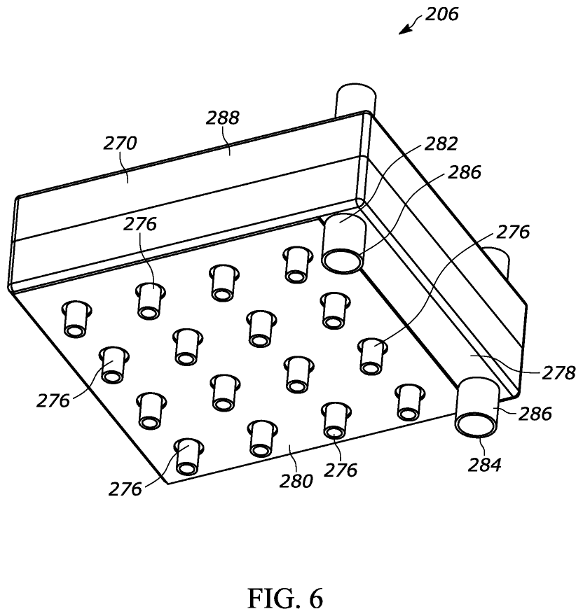

Details of a reagent cartridge interface 206 are shown in FIGS. 5 and 6.

FIG. 5 is a cross-sectional view of the reagent cartridge interface 206 and the cooling plate 204 for the non-contact dispenser assembly 200 of FIG. 2. The reagent cartridge interface 206 includes a body 270 configured to mate to or otherwise mount on the reagent cartridge 202. The body 270 defines an interior 272 configured to operate as a plenum. The body 270 further includes a pressure inlet 274 and a plurality of pressure outlets 276 open through a bottom, mating surface 278 thereof. In the illustrated implementation, the pressure outlets 276 include hollow posts that depend downwardly from the mating surface 278. The pressure inlet 274 is configured to be fluidly connected to a pressure source 150 to supply pressure to the interior 272, which can then be distributed through the pressure outlets 276. Although a single pressure inlet 274 is shown, two or more inlet ports can be utilized to provide pressure to two or more corresponding plenums defined by the body 270. Moreover, while the pressure inlet 274 is shown on a top of the body 270, the pressure inlet 274 can alternatively be provided on a side or bottom thereof.

The cooling plate 204 of the implementation of FIG. 5 has a body 268 with a dock 269 defined by a top surface 271 thereof. The dock 269 can be a cavity or recess defined in the top surface 271 that is sized to receive the base portion 212 of the reagent cartridge 202 therein to thereby mount the reagent cartridge 202 to the cooling plate 204. The reagent cartridge 202 can be received within the dock 269 in a friction fit engagement to thereby secure the reagent cartridge 202 to the dock 269. The reagent cartridge 201 can be secured in any other way, however. In the illustrated implementation, the cooling plate 204 includes an inlet port 273 and an outlet port 275, as well as interior conduits and/or a cavity (not shown), configured to receive a temperature regulated fluid flow therethrough. The inlet port 273 can receive a cooling fluid and the outlet port 275 can dispense the cooling fluid.

The body 270 of the reagent cartridge interface 206 includes upper and lower portions 270a, 270b, where the upper portion 270a has a hollow configuration to define the interior 272 and the bottom portion 270b extends under the cavity of the upper portion 270a and defines through openings 279 to fluidly connect the pressure outlets 276 to the interior 272.

The reagent cartridge interface 206 can be coupled to the reagent cartridge 202 by inserting the pressure outlets 276 into the reservoirs 218 of the reagent cartridge 202 to thereby pressurize the reservoirs 218 and selectively push reagent stored therein through the manifold assembly 232. If included, this action will cause the pressure outlets 276 to pierce the cover 224 sealing the reservoirs 218. In the illustrated implementation, the reagent cartridge interface 206 has a universal configuration for the pressure outlets 276, where the pressure outlets 276 can accommodate all different volume sizes for the various reservoirs 218 on the reagent cartridge 202. In other words, the reagent cartridge interface 206 has a pressure outlet 276 for each potential location of a discrete, smaller size reservoir 218. In the event a larger reservoir 218 is included on the reagent cartridge 202 that combines two or more of the discrete locations, the reagent cartridge interface 206 will insert the corresponding number of pressure outlets 276 into the larger reservoir 218. The reagent cartridge interface 206 can alternatively have a particular number of pressure outlets 276 that correspond to the number of reservoirs 218 on the reagent cartridge 202.

FIG. 6 is a bottom perspective view of the reagent cartridge interface 206 for the non-contact dispenser assembly of FIG. 2. In the illustrated implementation of FIG. 6, the reagent cartridge interface 206 can further include a seal 280 extending along the mating surface 278 and around the pressure outlets 276. The seal 280 can be made from any material, such as an elastomer. As the reagent cartridge interface 206 is fully seated on the reagent cartridge 202, the seal 280 will be compressed between the mating surface 278 and the distal ends 222 of the reservoirs 218 to effectively seal the connection between the components 202, 206 to prevent or reduce leakage therebetween.

In this implementation, the reagent cartridge interface 206 can include a cleaner conduit 282 and an outlet conduit 284 configured to fluidly connect to the cleaning port 252 and the outlet port 260 of the reagent cartridge 202, respectively, when the reagent cartridge interface 206 is mounted to the reagent cartridge 202. The conduits 282, 284 can each include an annular wall 286 that depends downwardly from the mating surface 278 of the body 270 and is sized to fit over or within the ports 252, 260 to provide a sealed connection therebetween. In the illustrated implementation, the conduits 282, 284 extend through the interior 272 of the body 270 and through a top wall 288 thereof to be accessible above the reagent cartridge interface 206. One or both of the conduits 282 can alternatively have a bent configuration to be accessible from a side of the body 270. Further, it will be understood that the conduits 282, 284 can be a portion of the body 270 to be integral therewith or can be separate components coupled to the body 270.

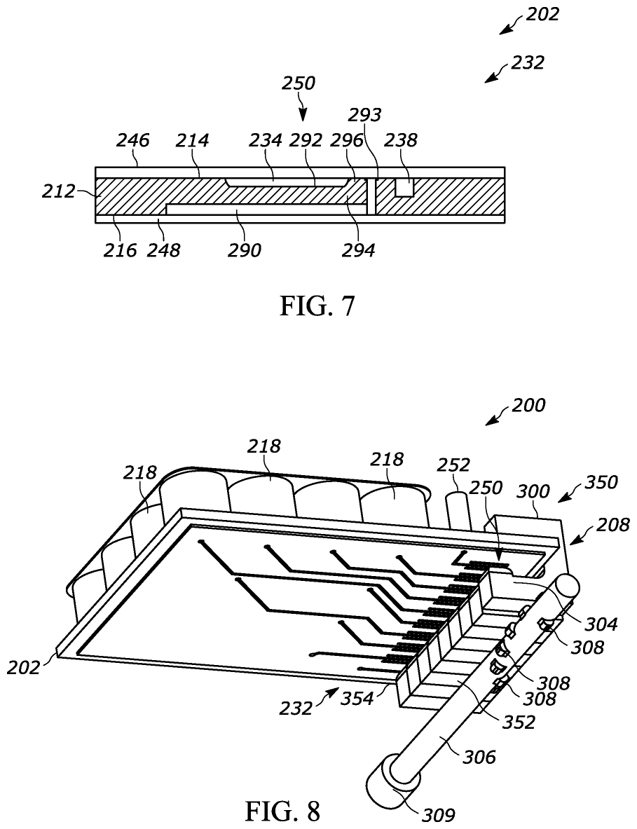

FIG. 7 is a cross-sectional view of a portion of a manifold assembly 232 including a membrane valve 250 for the reagent cartridge 202 of FIG. 3. Details of one implementation of the membrane valve 250 for the reagent cartridge 202 are thus shown in the cross-section of FIG. 7. The membrane valve 250 includes the valve body 234 defined by the base portion 212 of the reagent cartridge 202 and the top and bottom membranes 246, 248. The valve body 234 includes an opening 290 extending between the top and bottom surfaces 214, 216 of the base portion 212 and a valve member 292 disposed within the opening 290. The valve member 292 may be referred to as a flap, a valve flap, or an actuator. The top membrane 246 selectively engages a valve seat 293 of the valve body 234 defined by an edge of the opening 290. To actuate the membrane valve 250, an actuator, described in more detail below, can shift the valve member 292 upwardly to deflect the top membrane 246 away from the valve seat 293 of the valve body 234 and thereby provide a fluid path from the opening 290 to the common fluidic line 238.

In the illustrated implementation, the valve member 292 can be a cantilever extending from an edge of the opening 290 to position a distal end 294 within the opening 290. If desired, the distal end 294 can have a hammer configuration with an upward projection 296 configured to engage the top membrane 246.

Details of the actuator assembly 208 are shown in FIGS. 8-10.

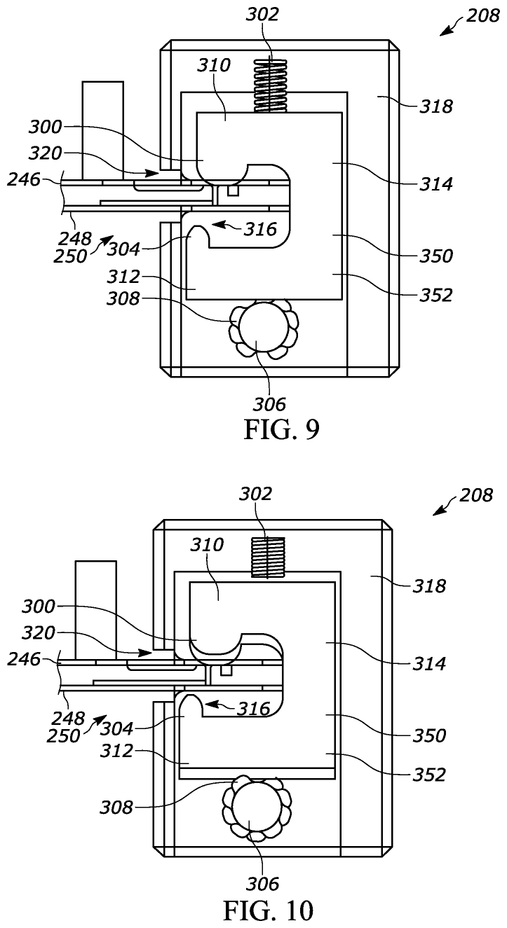

FIG. 8 is a bottom perspective view of the reagent cartridge 202 of FIG. 3 and an actuator assembly 208 for the non-contact dispenser assembly 200 of FIG. 2. The actuator assembly 208 of this implementation includes an actuator 350 that interfaces with both the first and second membranes 246, 248 to open and/or close the corresponding membrane valves 250. The actuator 350 have C-shaped members 352 having an opening 354 in which a portion of the manifold assembly 232 is positioned. The C-shaped members 352 have a top member 300 configured to engage the top membrane 246 and hold the top membrane 246 against the top surface 214 of the base portion 212 to thereby seal the membrane valves 250 from dispensing reagent into the common fluidic line 238. The top member 300 may be referred to as a first leg. The top member 300 can be actively controlled for movement between the closed valve position holding the top membrane 246 against the top surface 214 of the base portion 212 and an open valve position moved away from the base portion 212 to allow fluid flow from the membrane valve 250 to the common fluidic line 238. Suitable actuators for such a configuration include a shape memory alloy (SMA) actuator, a pneumatic piston, and so forth. Alternatively, the top member 300 can be passively biased to the closed valve position by a spring 302 (see, FIG. 9) or other biasing member.

The C-shaped members 352 also include a bottom member 304 aligned with the valve member 292 and configured to be selectively shifted upwardly to a valve open position that deflects the bottom membrane 248 to thereby deflect the valve member 292 and, via the valve member 292, the top membrane 246. The bottom member 304 may be referred to as a second leg. The bottom member 304 can be driven to the valve open position by any suitable actuator, including an SMA actuator, a pneumatic piston, and so forth.

In the illustrated implementation, the actuator assembly 208 includes an indexed rod 306 having protrusions 308 extending radially outwardly therefrom. The protrusions 308 are spaced along a longitudinal length of the indexed rod 306 and are disposed in a spiral configuration, such that rotation of the indexed rod 306 about a longitudinal axis thereof sequentially drives individual ones of the protrusions 308 to a upwardly extending orientation. With this configuration, the protrusions 308 can be driven to engage the bottom member 304 to thereby drive the bottom member 304 to the valve open position. Pursuant to this, the actuator assembly 208 can include a motor or other drive 309 operably coupled to the indexed rod 306 to drive rotation thereof.

FIG. 9 is a cross-sectional schematic view of the actuator assembly 208 of FIG. 8 with one of the C-shaped members 352 of the actuator 350 in a closed position. In the illustrated implementation, the top and bottom members 300, 304 form part of the C-shaped member 352. The C-shaped member 352 includes upper and lower arms 310, 312 and a connecting post 314 extending between. The upper arm 310 may be referred to a first leg and the lower arm 312 may be referred to as a second leg. The top and bottom members 300, 304 depend from the arms 310, 312 to extend toward one another. With this configuration, the C-shaped member 352 defines a mouth 316 to receive the membrane valve 250 therein to position the top and bottom members 300, 304 above and below the membrane valve 250, respectively. As shown, the actuator assembly 208 can include one of the C-shaped members 352 for each membrane valve 250 of the reagent cartridge 202. Further, the actuator assembly 208 can include a common spring 302 for all of the C-shaped members 352 or can include a spring 302 for each respective C-shaped members 352. If desired, the actuator assembly 208 can be disposed within a housing 318 sized to receive the spring(s) 302, the C-shaped members 352, and the indexed rod 306 therein. The housing 318 can define a mouth 320 to receive the membrane valve 250 therethrough.

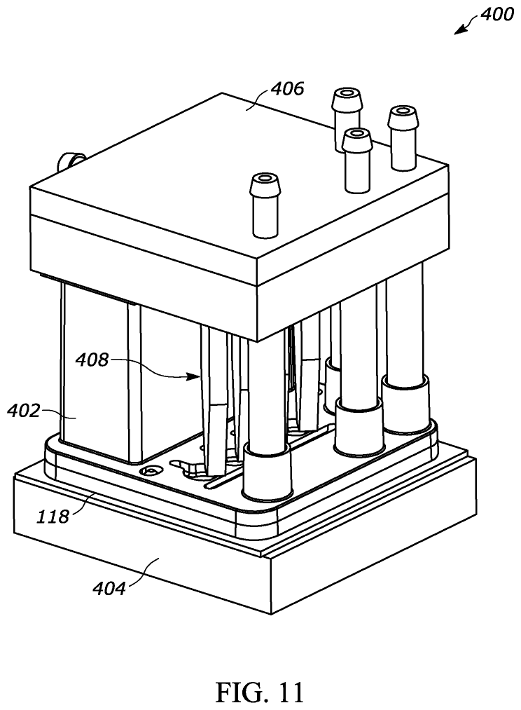

FIG. 10 is a cross-sectional schematic view of the actuator assembly 208 of FIG. 8 with the C-shaped member 352 of the actuator 350 in an open position.

FIG. 11 is a perspective view of a second implementation of a non-contact dispenser assembly 400 showing a reagent cartridge 402 that can be used to implement the reagent cartridge 114 of FIG. 1, a reagent cartridge receptacle 404 that can be used to implement the reagent cartridge receptacle 118 of FIG. 1, and a reagent cartridge interface 406 that can be used to implement the reagent cartridge interface 116 of FIG. 1. The reagent cartridge receptacle 404 may also be used to implement the temperature controller 120 and, thus, the reagent cartridge receptacle 404 may be referred to as an environmental nest in such a situation. One implementation of an actuator assembly 408 that can be used to implement the valve drive assembly 162 of FIG. 1 is also shown. The actuator assembly 408 may include shape memory alloy actuators.

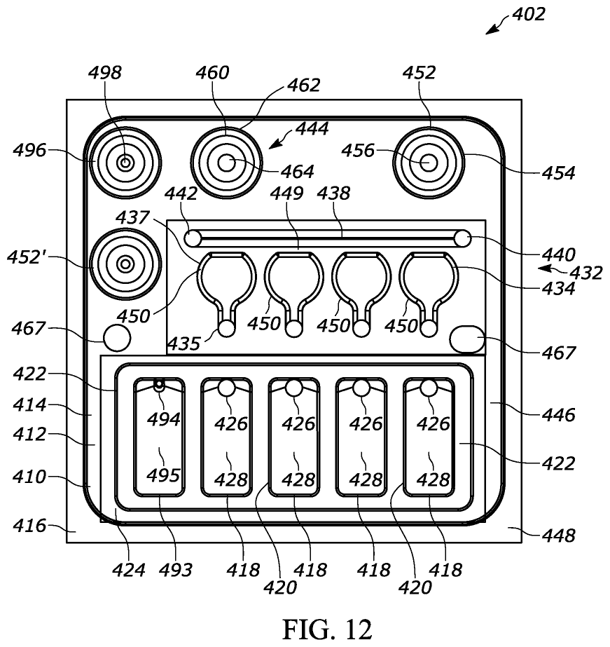

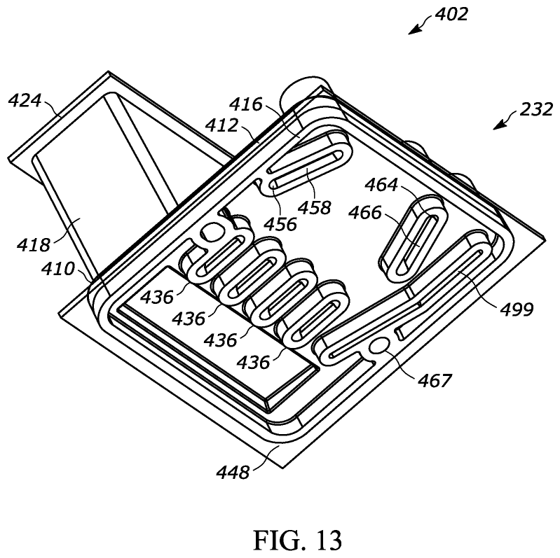

FIG. 12 is a top plan view of the reagent cartridge 402 for the non-contact dispenser assembly 400 of FIG. 11. Details of the reagent cartridge 402 are shown in FIGS. 12 and 13. The reagent cartridge 402 includes a body 410 having a base portion 412 with top and bottom surfaces 414, 416. The body 410 further includes a plurality of reservoirs 418 defined by walls 220 extending upwardly from the base portion 412 to distal ends 422 that define an open top. The reservoirs 418 may be referred to as reagent reservoirs. The reagent cartridge 402 can be provided with a cover 424 that extends over the open tops of the reservoirs 418 and seals to the distal ends 422 of the walls 420 to thereby seal each of the reservoirs 418 to safely contain reagents disposed therein for storage and transportation purposes. The cover 424 can be made of any suitable material, such as a foil, plastic, etc.

Each of the reservoirs 418 further include an outlet 426 extending through the base portion 412 to open at the bottom surface 416 thereof. A bottom surface 428 of each the reservoirs 418 can be angled or otherwise contoured to direct fluid flow to the outlet 426 thereof. For example, a reservoir 418 having a rectangular horizontal cross-section as shown can include a forwardly angled bottom surface 416 with a funneled front end to direct fluid flow to the outlet 426. It will be understood that although the reservoirs 418 of this implementation are shown with a common volume, the reservoirs 418 can have different volumes similar to the above assembly 200 if desired.

The reagent cartridge 402 includes a manifold assembly 432 that can be used to selectively dispense reagents stored within the reservoirs 418 from the reagent cartridge 402. The manifold assembly 432 further includes valve bodies 434 defined in the base portion 412 for each of the reservoirs 418 and reagent fluidic lines 436 (see, FIG. 13) defined in the bottom surface 416 of the base portion 412 to fluidly connect the outlet 426 of the reservoirs 418 to the respective valve body 434. In the illustrated implementation, the valve bodies 434 include an inlet opening 435 defined through the body base portion 412 that feeds into a cavity 437 defined in the body top surface 414.

A common fluidic line 438 for the manifold assembly 432 extends adjacent to the valve bodies 434. The common fluidic line 438 is defined in the top surface 414 of the body base portion 412 in the implementation shown and has a proximal end 440 and an opposite, distal end 442 fluidly connected to a cartridge outlet 444, with the valve bodies 434 disposed adjacent to the common fluidic line 438 between the proximal and distal ends 440, 442 thereof. The cavity 437 of the valve bodies 434 can have a paddle configuration, as shown, with a truncated circular distal end, where the truncated edge extends along the common fluidic line 438.

The reagent cartridge 402 further includes a top membrane 446 that is coupled to the top surface 414 of the body base portion 412 and a bottom membrane 448 that is coupled to the bottom surface 416 of the body base portion 412. The top and bottom membranes 446, 448 interact with the valve bodies 434 to form membrane valves 450 corresponding to each of the reservoirs 418. The top membrane 446 selectively engages a valve seat 449 defined by an edge of the cavity 437. The top membrane 446 extends over and seals the common fluidic line 438 and the bottom membrane 448 extends over and seals the reagent fluidic lines 436 and the inlet opening 435.

The body 410 further defines a cleaning port or reservoir 452 defined by walls 454 extending upwardly from the base portion 412. An outlet 456 of the cleaning port 452 extends into or through the body 410 and is fluidly connected to the proximal end 440 of the common fluidic line 438. The outlet 456 of the cleaning port 452 is connected to the common fluidic line 438 by a cleaning line 458 (see, FIG. 13) defined in the body bottom surface 416 and sealed by the bottom membrane 448. Alternatively, the cleaning line 458 can be defined in the body top surface 414 and sealed by the top membrane 446.

In the implementation shown, the cartridge outlet 444 includes an outlet port 460 defined by walls 462 extending upwardly from the base portion 412. An inlet opening 464 of the outlet port 460 extending into or through the body 410 is fluidly connected to the distal end 442 of the common fluidic line 438. In one implementation, the inlet opening 464 of the outlet port 460 can be connected to the common fluidic line 438 by an outlet line 466 (see, FIG. 13) defined in the body bottom surface 416 and sealed by the bottom membrane 448. Alternatively, the outlet line 466 could be defined in the body top surface 414 and sealed by the top membrane 446.

In some implementations, the body 410 further includes a secondary reservoir 493 defined by the walls 420 extending upwardly from the base portion 412 to the distal ends 422 that define an open top. As with the other reservoirs 418, the secondary reservoir 493 can be provided with the cover 424 that extends over the open tops of the reservoirs 418, 493 and seals to the distal ends 422 of the walls 420 to thereby seal each of the reservoirs 418, 493 to safely contain reagents disposed therein for storage and transportation purposes.

The reservoir 493 includes an outlet 494 extending through the base portion 412 to open at the bottom surface 416 thereof. A bottom surface 495 of the reservoir 493 can be angled or otherwise contoured to direct fluid flow to the outlet 494 thereof. The body 410 further defines a secondary port 496 defined by walls 497 extending upwardly from the base portion 412. An inlet opening 498 of the secondary port 496 extending into or through the body 410 is fluidly connected to the outlet 494 of the secondary reservoir 493. In one implementation, the outlet 494 of the secondary reservoir can be connected to the inlet opening 498 of the secondary port 496 by a secondary fluidic line 499 defined in the body bottom surface 416 and sealed by the bottom membrane 448. Alternatively, the secondary fluidic line 499 could be defined in the body top surface 414 and sealed by the top membrane 446. The reagent cartridge 402 also includes a secondary cleaning port 452′ that is fluidly coupled to the secondary fluidic line 499.

In order to easily mount the reagent cartridge 402 to the reagent cartridge receptacle 404, the body base portion 412 can include a pair of locating holes 467 extending therethrough. The locating holes 467 can be located in any desired area of the base portion 412, including on either side as shown. If desired, one of the locating holes 467 can have an elongated or otherwise larger opening than a pin to be received therethrough to provide a user with clearance during an initial mounting of the reagent cartridge 402. One of the locating holes 467 is shown being oblong and the other of the locating holes 467 is shown being circular.

FIG. 13 is a bottom perspective view of the reagent cartridge 402 for the non-contact dispenser assembly 400 of FIG. 11. The body 410 of the reagent cartridge 402 defines the reagent fluidic lines 436, the cleaning line 458, the outlet line 466, and the secondary fluidic line 499 in the implementation shown.

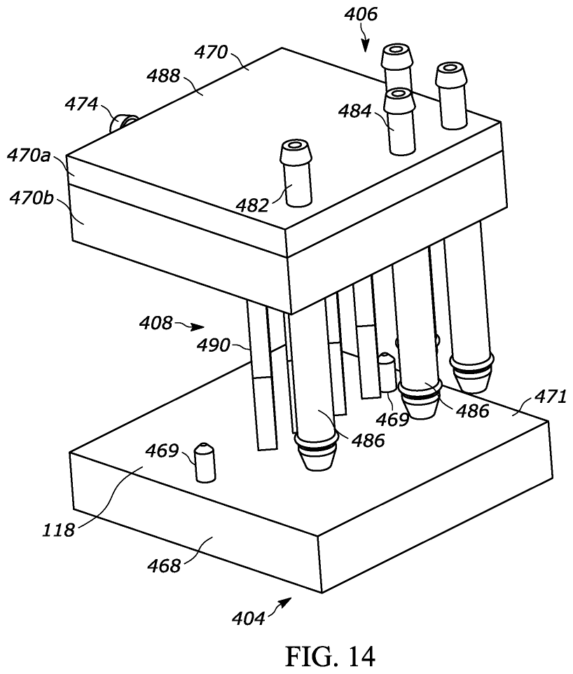

FIG. 14 is a top perspective view of the reagent cartridge interface 406 and the reagent cartridge receptacle 404 for the non-contact dispenser assembly of FIG. 11. The reagent cartridge receptacle 404 includes a body 468 having a pair of locating pins 469 extending upwardly from a top surface 471 thereof. The locating pins 469 can be configured to align with and project through the locating openings 467 of the base portion 412 to thereby mount the reagent cartridge 402 to the reagent cartridge receptacle 404 in a desired location and orientation.

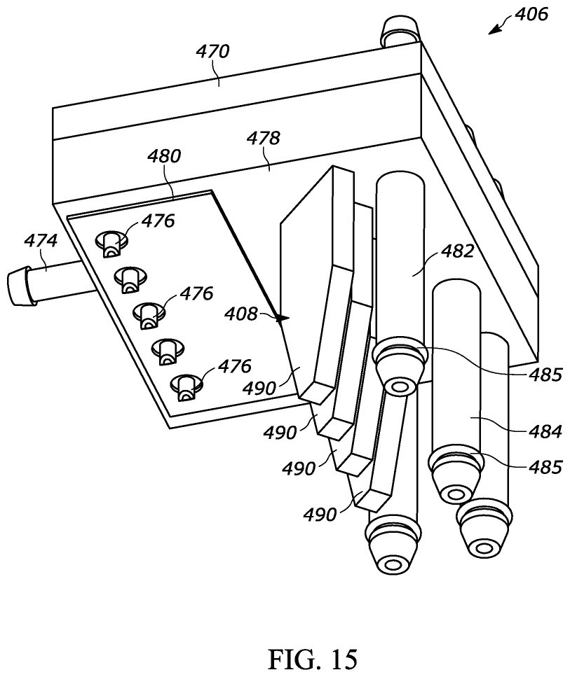

FIG. 15 is a bottom perspective view of the reagent cartridge interface 406 for the non-contact dispenser assembly of FIG. 11. The reagent cartridge interface 406 includes a body 470 configured to mate to or otherwise mount on the reagent cartridge 402. The body 470 further includes a pressure inlet 474 and a plurality of pressure outlets 476 that depend downwardly from a bottom, mating surface 478 thereof. In the illustrated implementation, the pressure outlets 476 can be hollow posts. The pressure inlet 474 is configured to be fluidly connected to the pressure source 150 to supply pressure to the interior 472, which can then be distributed through the pressure outlets 476. Although a single pressure inlet 474 is shown, two or more inlet ports can be utilized to provide pressure to two or more corresponding plenums defined by the body 470. Moreover, while the pressure inlet 474 is shown on a side of the body 470, the pressure inlet 474 can alternatively be provided on a top or bottom thereof.

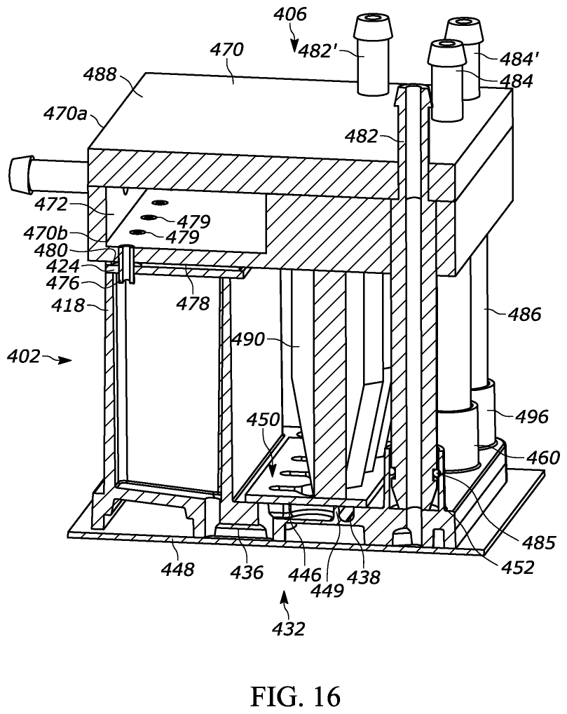

FIG. 16 is a cross-sectional view of the reagent cartridge 402 of FIG. 12 and the reagent cartridge interface 406 of FIG. 14. The body 470 of the reagent cartridge interface 406 in the implementation shown defines an interior 472 configured to operate as a plenum. The body 470 of the reagent cartridge interface 406 also includes upper and lower portions 470a, 470b, where the lower portion 470b has a hollow configuration to define the interior 472 and through openings 479 to fluidly connect the pressure outlets 476 to the interior 472. The top portion 470a extends over the lower portion 470b to cover the cavity therein.

With this configuration, the reagent cartridge interface 406 can be coupled to the reagent cartridge 402 by inserting the pressure outlets 476 into the reservoirs 418 of the reagent cartridge 402 to thereby pressurize the reservoirs 418 and selectively push reagent stored therein through the manifold assembly 432. If included, this action will cause the pressure outlets 476 to pierce the cover 424 sealing the reservoirs 418.

The reagent cartridge interface 406 can further include a seal 480 extending along the mating surface 478 and around the pressure outlets 476. The seal 480 can be made from any suitable material, such as a suitable elastomer. As the reagent cartridge interface 406 is fully seated on the reagent cartridge 402, the seal 480 will be compressed between the mating surface 478 and the distal ends 422 of the reservoirs 418 to effectively seal the connection between the components to prevent or reduce leakage therebetween.

In this implementation, the reagent cartridge interface 406 can include a cleaner conduit 482 and an outlet conduit 484 configured to fluidly connect to the cleaning port 452 and the outlet port 460, respectively, when the reagent cartridge interface 406 is mounted to the reagent cartridge 402. The reagent cartridge interface 406 also includes a secondary cleaner conduit 482′ and a secondary outlet conduit 484′ associated with and adapted to mate with the secondary port 496 and the secondary cleaning port 452′. The conduits 482, 482′, 484, 494′ can each include an annular wall 486 that depends downwardly from the mating surface 478 of the body 470 and is sized to be positioned within the ports 452, 452′, 460, 496 as shown to provide a sealed connection therebetween. To provide a better seal between the components, the conduits 482, 482′, 484, 484′ can have an o-ring 485 disposed therearound to sealingly engage the wall of the ports 452, 452′, 460, 496. Alternatively, the conduits 482, 482′, 484, 494 can be configured to fit over the ports 452, 460 similar to the above assembly 200. In the illustrated implementation, the conduits 482, 482′, 484, 484′ extend through the interior 472 of the body 470 and through a top wall 488 thereof to be accessible above the reagent cartridge interface 406. One or more of the conduits 482, 482′, 484, 484′ can alternatively have a bent configuration to be accessible from a side of the body 470. Further, it will be understood that the conduits 482, 482′, 484, 484′ can be a portion of the body 470 to be integral therewith or can be separate components coupled to the body 470.

The actuator assembly 408 of this implementation includes a plurality of actuators 490 that extend downwardly from the reagent cartridge interface 406 to engage the top membrane 446 and hold the top membrane 446 against the valve seats 449 of the valve bodies 434 to thereby hold the membrane valves 450 in the closed configuration by preventing the membrane valves 450 from dispensing reagent into the common fluidic line 438. The actuators 490 can be actively controlled for movement between the closed valve position holding the top membrane 446 against the valve seats 449 of the respective valve bodies 434 and an open valve position moved away from the valve seats 449 to allow pressure in the manifold assembly 432 to deflect the top membrane 446 and allow fluid flow from the membrane valve 450 to the common fluidic line 438. Suitable actuators for such a configuration include a shape memory alloy (SMA) actuator, a pneumatic piston, and so forth.

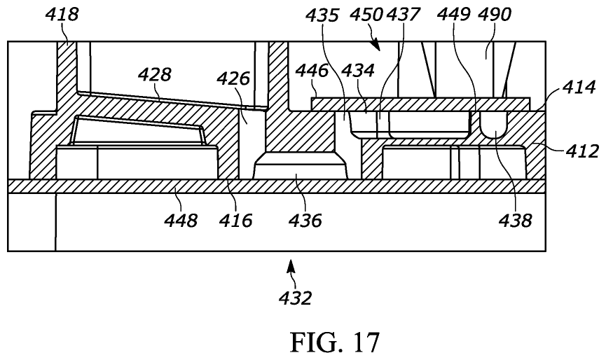

FIG. 17 is a cross-sectional view of a portion of the manifold assembly 432 including a membrane valve 450 for the reagent cartridge 402 of FIG. 12. Details of one implementation of the membrane valve 450 for the reagent cartridge 402 is shown in the cross-section of FIG. 17. The membrane valve 450 includes the valve body 434 defined by the base portion 412 of the reagent cartridge 402 and the top and bottom membranes 446, 448. The valve bodies 434 include the inlet opening 435 extending between the top and bottom surfaces 414, 416 of the base portion 412 that feeds into the cavity 437 defined in the body top surface 414. The membrane valve 450 of this form can have an always open configuration that requires an actuator to hold the membrane valve 450 in a closed configuration with the top membrane 446 sealingly engaged to the valve seat 449. In other words, the pressure supplied to the reservoirs 418 by the reagent cartridge interface 406 can pressurize the reagent fluidic lines 436 and the membrane valves 450 with a sufficient pressure to deflect the top membrane 446 away from the valve seat 449 of the valve body 434 to thereby fluidly connect the membrane valve 450 with the common fluidic line 438.

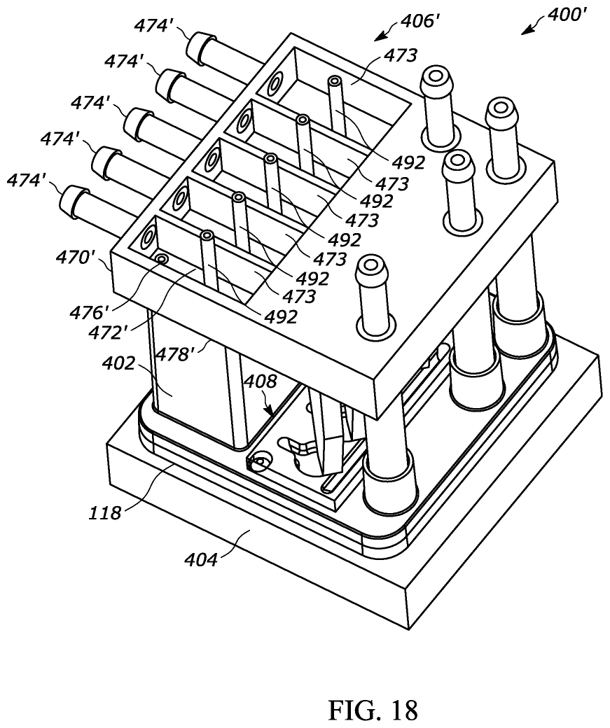

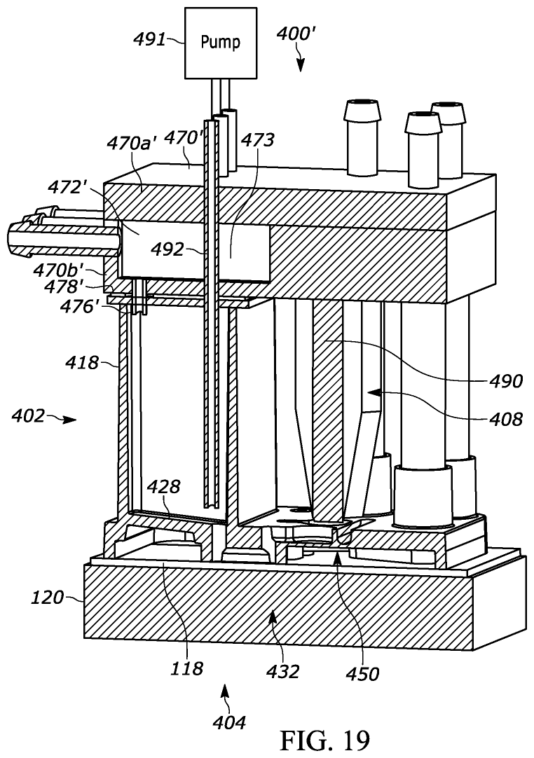

FIG. 18 is a top perspective partial cross-sectional view of a non-contact dispenser assembly 400′ with a second reagent cartridge interface 406′ that can be used to implement the non-contact dispenser assembly 104 and the reagent cartridge interface 116 of FIG. 1. The reagent cartridge interface 406′ of this implementation includes a body 470′ configured to mate to or otherwise mount on the reagent cartridge 402. The body 470′ includes upper and lower body portions 470a′, 470b′ (see, FIG. 19) that define an interior 472′ divided into a plurality of chambers 473, each configured to operate as a plenum. The chambers 473 may be referred to as a plurality of interior plenums. The body 470′ further includes a plurality of inlet ports 474′ and a plurality of pressure outlets 476′ fluidly connected to individual ones of the chambers 473. The pressure outlets 476′ depend downwardly from a bottom, mating surface 478′ of the body 470′ to be inserted into the reservoirs 418 of the reagent cartridge 402.

In the illustrated implementation, the pressure outlets 476′ can be hollow posts. As with the above implementations, the inlet ports 474′ are configured to be fluidly connected to one or more pressure sources 150 to supply pressure to the chambers 473, which can then be distributed through the pressure outlets 476′. While the inlet ports 474′ are shown on a side of the body 470′, the inlet ports 474′ can alternatively be provided on a top or bottom thereof.

The second reagent cartridge interface 406′ includes a plurality mixers 492 that are used to mix contents of the reservoirs 418. The mixers 492 are shown as needles that are coupled to the reagent cartridge interface 406′ to extend into the reservoirs 418 when the interface 406 is mounted to the reagent cartridge 402. The mixers 492 could similarly be implemented with the reagent cartridge interfaces 206, 406 described above.

FIG. 19 is another cross-sectional view of the non-contact dispenser assembly 400′ of FIG. 18. As shown in FIG. 19, the mixers 492 in the implementation shown can have a hollow configuration and be coupled to a pump 491. The pump 491 may be a syringe pump that mixes contents of the reservoir 418 and/or is capable of providing positive and negative pressure for mixing. The system 100 may include the pump 491 in some implementations. The pump 491 can be configured to alternate between a positive pressure supply and a negative pressure supply to thereby agitate materials within the corresponding reservoir 418. The pump 491 can be separate components for each mixer 492, or the mixers 492 can share a common pressure connection. In configuration with a common pressure connection, each mixer 492 can selectively be opened to atmosphere to keep pressure from fluctuating inside the reservoir 418 during mixing of another one of the reservoirs 418. The system 100 of FIG. 1 may alternatively include a pump or mixer to mix or rehydrate reagent within the reservoirs 418.

In one implementation, a hydrating fluid can be supplied to a desired reservoir 418 that contains a lyophilized reagent therein. By this approach, fluid can be prevented from exiting the cartridge outlet 444 by any suitable valve and the actuator 490 for the desired membrane valve 450 can be moved to the valve open position. Thereafter, the cleaning fluid valve 142 controlling fluid flow through the cleaning port 452 can be opened to supply hydrating fluid to the manifold assembly 432. The hydrating fluid then flows into the open membrane valve 450, through the reagent fluidic line 436, and into the desired reservoir 418. After an amount of hydrating fluid is dispensed, the cleaning fluid valve 142 and the membrane valve 450 can be closed. Thereafter, the mixer 492 can be utilized to mix the hydrating fluid and the lyophilized reagent. The mixture may be a homogeneous solution.

In a further implementation, the non-contact dispenser assembly 400′ can also include one or more mixers 492 to mix materials within each of the reservoirs 418. The mixers 492 can aid in rehydration of lyophilized reagents and/or mixing rehydrated reagents. The mixers 492 can also or alternatively aid in keeping solid particles, such as magnetic beads, suspended within the reservoir 418. With any of the implementations described herein, contactless dispensing of a plurality of reagents can be efficiently achieved.

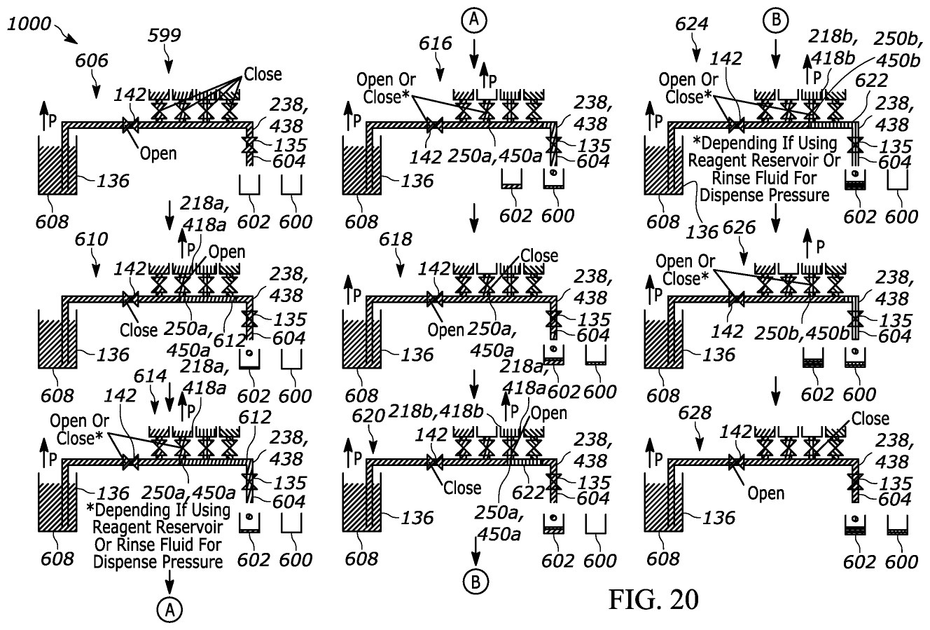

FIG. 20 depicts a flow-process diagram of processes of using a system 1000 that can be used to implement the system 100 of FIG. 1 and/or any of the non-contact dispensing assemblies 104, 200, 400, 400′. The system 1000 of FIG. 20 includes a non-contact dispenser assembly 599 including the cleaning fluid valve 142, the outlet valve 135, a plurality or reagent reservoirs 218a, 218b, 418a, 418b and associated membrane valves 250a, 450a, the common fluidic line 238, 438, and an outlet 604. The system 1000 also includes the cleaning fluid reservoir 136, a reagent well 600, and a waste well 602 that receives dispensed fluid from the outlet 604, that can be any suitable outlet, including any of the outlet implementations described herein.

The cleaning fluid and outlet valves 142, 135 are shown opened at reference number 606 to dispense cleaning fluid 608 through the common fluidic line 238, 438, the outlet 604, and into the waste well 602. This both cleans the common fluidic line 238, 438 for subsequent reagent dispensing, and sets a pressure within the common fluidic line 238, 438 according to a pressure of the cleaning fluid reservoir 136, which can be a known value. A first membrane valve 250a, 450a corresponding to a first reservoir 218a, 418a containing a desired first reagent 612 is actuated to the open configuration by the actuator assembly 208, 408 at reference number 610 and the cleaning fluid valve 142 is closed. Pressure supplied to the first reservoir 218a, 418a by the reagent cartridge interface 206, 406 pushes the first reagent 612 through the first membrane valve 250a, 450a, and into the common fluidic line 238, 438. An initial amount of the first reagent 612 is dispensed through the outlet 604 and into the waste well 602 at reference number 614. In one implementation and at least partially depending on the fluidic pathway length and volumes, the pressure supplied by the reagent cartridge interface 206, 406 can push the first reagent 612 out through the outlet 604. In another implementation, after a desired amount of the first reagent 612 is dispensed into the common fluidic line 238, 438, the cleaning fluid valve 142 can be opened to thereby dispense cleaning fluid 608 into the common fluidic line 238, 438 to push the first reagent 612 through the outlet 604. The reagent well 600 is aligned with the outlet 604 to receive an amount of the first reagent 612 at reference number 616, which can be driven therethrough by either of the above implementations. The waste well 602 is aligned with the outlet 604 at reference number 618 to receive a final amount of the first reagent 612 and the cleaning fluid 608 is dispensed through the common fluidic line 238, 438 after the first reagent 612. The cleaning fluid 608 effectively cleans the common fluidic line 238, 438 and resets the pressure within the common fluidic line 238, 438 from a pressure corresponding to the first reservoir 218a, 418a for the first reagent 612.

A second membrane valve 250b, 450b corresponding to a second reservoir 218b, 418b containing a desired second reagent 622 is actuated to the open configuration by the actuator assembly 208, 408 at reference number 620 and the cleaning fluid valve 142 is closed. Pressure supplied to the second reservoir 218b, 418b by the reagent cartridge interface 206, 406 pushes the second reagent 622 through the second membrane valve 250b, 450b and into the common fluidic line 238, 438. An initial amount of the second reagent 622 is dispensed through the outlet 604 and into the waste well 602 at reference number 624, which can be driven therethrough by either of the above implementations. The reagent well 600 is aligned with the outlet 604 to receive an amount of the second reagent 622 at reference number 626, which can be driven therethrough by either of the above implementations. The waste well 602 is aligned with the outlet 604 to receive a final amount of the second reagent 622 at reference number 628 and the cleaning fluid 608 is dispensed through the common fluidic line 238, 438 after the second reagent 622. The cleaning fluid 608 again effectively cleans the common fluidic line 238, 438 and resets the pressure within the common fluidic line 238, 438 from a pressure corresponding to the second reservoir 218b, 418b for the first reagent 622. This process can be similarly repeated for any desired number of reagents and any desired amounts. Further, while the reagent well 600 is described as singular, any number of wells and/or any number of plates may be included.

With any of the implementations described herein, a gas feed can be utilized in combination with contactless dispensing of a plurality of reagents to identify different fluids being dispensed through the system.

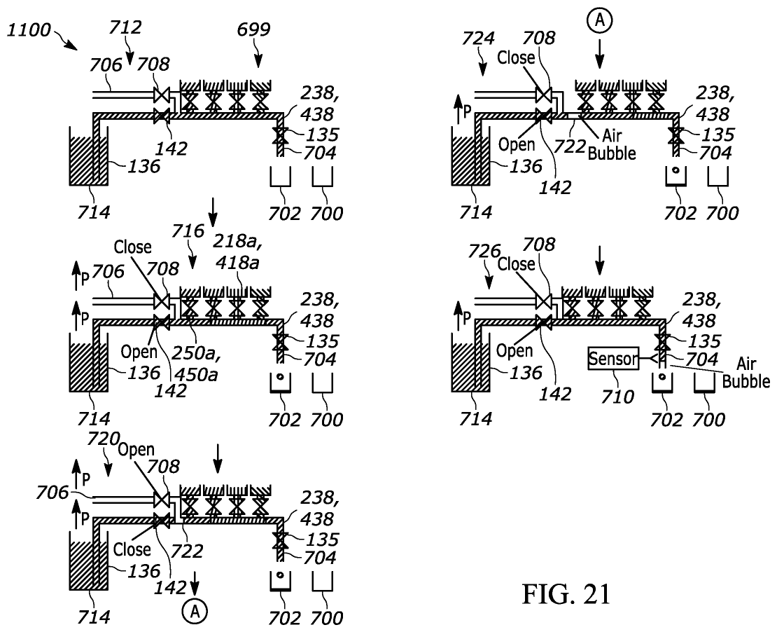

FIG. 21 depicts a flow-process diagram of processes of using a system 1100 that can be used to implement the system 100 of FIG. 1 and/or any of the non-contact dispensing assemblies 104, 200, 400, 400′.

The system 1100 of FIG. 21 includes a non-contact dispenser assembly 699 including the cleaning fluid valve 142, the outlet valve 135, a plurality or reagent reservoirs 218a, 218b, 418a, 418b and associated membrane valves 250a, 450a, the common fluidic line 238, 438, and a gas supply valve 708. The system 1100 also includes the cleaning fluid reservoir 136, a reagent well 700, a waste well 702 that receives dispensed fluid from the outlet 704, a gas source 706, and an optical sensor 710.

The cleaning fluid and outlet valves 142, 135 are opened to dispense cleaning fluid 714 through the common fluidic line 238, 438, the outlet 704, and into the waste well 702 at reference number 712. This both cleans the common fluidic line 238, 438 for subsequent reagent dispensing, and sets a pressure within the common fluidic line 238, 438 according to a pressure of the cleaning fluid reservoir 136, which can be a known value.

Additionally, although not shown, after the common fluidic line 238, 438 is cleaned, the gas supply valve 708 can be opened to dispense gas into the common fluidic line 238, 438 and clear all fluids, e.g., the cleaning fluid 136, out of the common fluidic line 238, 438. When the gas is dispensed through the outlet 704, the lack of fluid can be detected by the optical sensor 710.

Then a first membrane valve 250a, 450a corresponding to a first reservoir 218a, 418a containing a desired first reagent 718 is actuated to the open configuration by the actuator assembly 208, 408 at reference number 716, which is done with the cleaning fluid valve 142 closed. Pressure supplied to the first reservoir 218a, 418a by the reagent cartridge interface 206, 406 pushes an amount of the first reagent 718 through the first membrane valve 250a, 450a, and into the common fluidic line 238, 438. In the implementation utilized the pre-dispense gas-flush, the common fluidic line 238, 438 is dry when the first reagent 718 is dispensed.

In one implementation and at least partially depending on the fluidic pathway length and volumes, the pressure supplied by the reagent cartridge interface 206, 406 can push a desired amount of the first reagent 718 out through the outlet 704 and into the reagent well 700. Then, the first membrane valve 250a, 450a is closed. The fluid can be initially detected by the optical sensor 710. In another implementation, after a desired amount of the first reagent 718 is dispensed into the common fluidic line 238, 438, the first membrane valve 250a, 450a is closed and the cleaning fluid valve 142 can be reopened to thereby dispense cleaning fluid 608 into the common fluidic line 238, 438 to dispense an amount of the cleaning fluid 714 into the common fluidic line 238, 438 behind the first reagent 718. In yet another implementation, after a desired amount of the first reagent 718 is dispensed into the common fluidic line 238, 438, the first membrane valve 250a, 450a is closed, awaiting the introduction of a bubble, as discussed below.

In any of the above implementations, the cleaning fluid valve 142/first membrane valve 250a, 450a is closed and the gas supply valve 708 is opened to dispense an amount of gas into the common fluidic line 238, 438 to create a bubble 722 after the first reagent 718/cleaning fluid 714 at reference number 720. Thereafter, the gas supply valve 708 is closed and the cleaning fluid valve 142 is reopened to dispense the cleaning fluid 714 into the common fluidic line 238, 438 after the bubble 722 at reference number 724. The cleaning fluid 714 then pushes the bubble 722 and remaining fluid through the common fluidic line 238, 438 until the optical sensor 710 detects the break in fluid flow provided by the bubble 722 at reference number 726. A corresponding signal can be accessed by the controller 160. The optical sensor 710 may be positioned to identify the bubbles 772 being dispensed through the outlet 704 and/or within the common fluidic line 238, 438. The optical sensor 710 can thus identify a break in the fluid within common fluidic lien 238, 438 based on the bubble/gas 772 being present.

In the implementation utilizing the pressure of the cleaning fluid 714 to push the first reagent 718 through the outlet 704, a desired amount of the first reagent 718 can be dispensed into the reagent well 700 and thereafter, the remaining first reagent 718 and the cleaning fluid 714 can be pushed through the common fluidic line 238, 438 until the optical sensor 710 detects the break in fluid flow provided by the bubble 722.

Although not shown, the cleaning fluid valve 142 can then be closed and the gas supply valve 708 be opened to dispense an amount of gas into the common fluidic line 238, 438 to flush all of the cleaning fluid 714 out of the common fluidic line 238, 438 until the optical sensor 710 detects the lack of fluid being dispensed. The above implementations can then be repeated any number of times for other reagents, as well as a further dispensing step for the first reagent 718.

Although an implementation is described with the bubble 722 being dispensed within the cleaning fluid 714, the bubble 722 can additionally or alternatively be provided before and/or after a desired reagent.

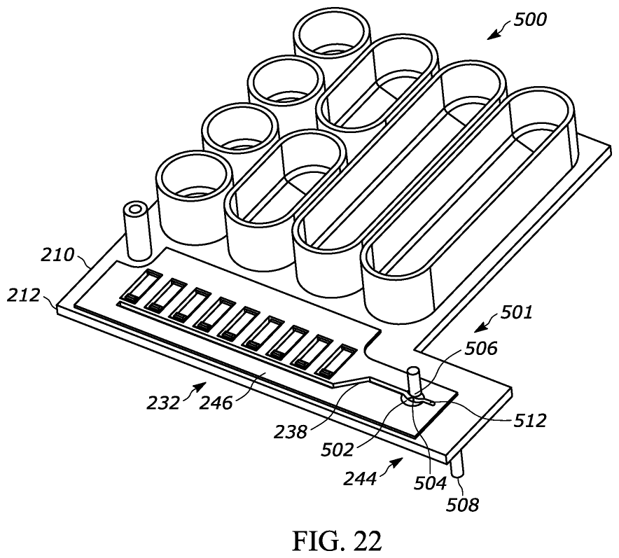

FIG. 22 is a top perspective view of a reagent cartridge 500 including an outlet valve 501 that can be used in the system 100 of FIG. 1. The reagent cartridge 500 of FIG. 22 is similar to the reagent cartridge 202 of FIG. 2. The reagent cartridge 500 of FIG. 22, however, includes the outlet valve 501. The outlet valve 501 may be a membrane valve. The reagent 133 may be directly dispensed from the reagent cartridge 500 if the implementation shown is used and the reagent cartridge interface 116 of the system 100 may omit the valve 135 and the supply line 137.

The outlet valve 501 in the implementation shown includes a recess 502 defined in the base portion 212 of the body 210 through which the common fluidic line 238 extends. An anvil 504 is defined in a center of the recess 502 that raises a bottom surface of the common fluidic line 238. The anvil 504 may alternatively be referred to as a valve seat. As shown, the top membrane 246 extends over and seals the recess 502 in addition to the common fluidic line 238. The outlet valve 501 further includes a piezo hammer 506 disposed above and aligned with the anvil 504. The cartridge outlet 244 of this implementation includes an outlet port 508 extending downwardly from the base portion 212. The outlet port 508 may be referred to as a dispensing tip or needle. An inlet opening 512 of the outlet port 508 extends through the body 210 at the distal end 242 of the common fluidic line 238.

FIG. 23 is a top perspective view of a reagent cartridge 520 including the outlet valve 501 in another orientation that can be used in the system 100 of FIG. 1. The reagent cartridge 520 of FIG. 23 is similar to the reagent cartridge 520 of FIG. 21. The reagent cartridge 520 of FIG. 23, however, includes the outlet port 508 in a position such that the reagent cartridge 202 is oriented so that the base portion 212 of the body 210 extends vertically and the common fluidic line 238 includes a downward bend 514 at the distal end 242 thereof to direct fluid flow downwardly. With this configuration, an inlet opening 516 of the outlet port 508 can be aligned with the outlet of the downward bend 514.

A desired amount of reagent can be dispensed into the common fluidic line 238 by any of the above methods, which will then pool in the recess 502. When dispensing is desired, the piezo hammer 506 can be operated to impact the anvil 504 to thereby cause an amount of reagent to be driven through the outlet port 508 or dispensing needle 510.

FIG. 24 is a top perspective view of another reagent cartridge 550 including an outlet valve 551 that can be used in the system 100 of FIG. 1. The outlet valve 551 may be a rod-flap valve. The outlet valve 551 includes a valve body 552 defined by the base portion 212 of the body 210 and the top and bottom membranes 246, 248. The valve body 552 includes an opening 554 extending between the top and bottom surfaces 214, 216 of the base portion 212 and a valve member 556 disposed within the opening 554. The valve member 551 may be referred to as a flap, a flap valve, an actuator.

FIG. 25 is a cross-sectional detailed view of the reagent cartridge 500 of FIG. 24 showing the outlet valve 551. In the illustrated implementation, the valve member 556 can be a cantilever extending from an edge of the opening 554 to position a distal end 558 of the valve member 556 within the opening 554. If desired, the distal end 558 can have a hammer configuration with an upward projection 560.

The reagent cartridge 202 of this implementation includes an outlet port 562 defined by walls 564 extending upwardly from the base portion 212. An outlet fluidic line 566 is defined in the bottom surface 216 of the base portion 212 adjacent to the valve body 552 and fluidly connects to an inlet opening 568 of the outlet port 562. As shown, the top membrane 246 extends over and seals the valve body 552 and the bottom membrane 248 extends over and seals the valve body 552 and outlet fluidic line 562.

As shown in FIG. 25, the outlet valve 551 further includes an actuator 570 and a spring or other biasing member 572 disposed on either side of the base portion 212 and configured to interact with the valve member 556 to drive the valve member 556 downwardly and upwardly, respectively. With the implementation shown, the spring 572 imparts a continuous upward biasing force on the valve member 556 through the bottom membrane 248 to hold the valve 551 in a closed position with the bottom membrane 248 against a valve seat 573. In the closed position, the actuator 570 engages the valve member 556 through the top membrane 546 to hold the valve member 556 within the opening 554 against the force of the spring 572. When actuation is desired, the actuator 570 drives the valve member 556 downwardly to deflect the bottom membrane 248 away from the bottom surface 216 of the base portion 212 and the valve seat 573 and thereby provide a fluid path from the opening 554 to the outlet fluidic line 566. It will be understood, however, that the location of the actuator 570 and spring 572 can be switched, in which configuration, the actuator 570 can be configured to be moved away from the bottom membrane 248 to allow the spring 572 to drive actuation of the outlet valve 551.

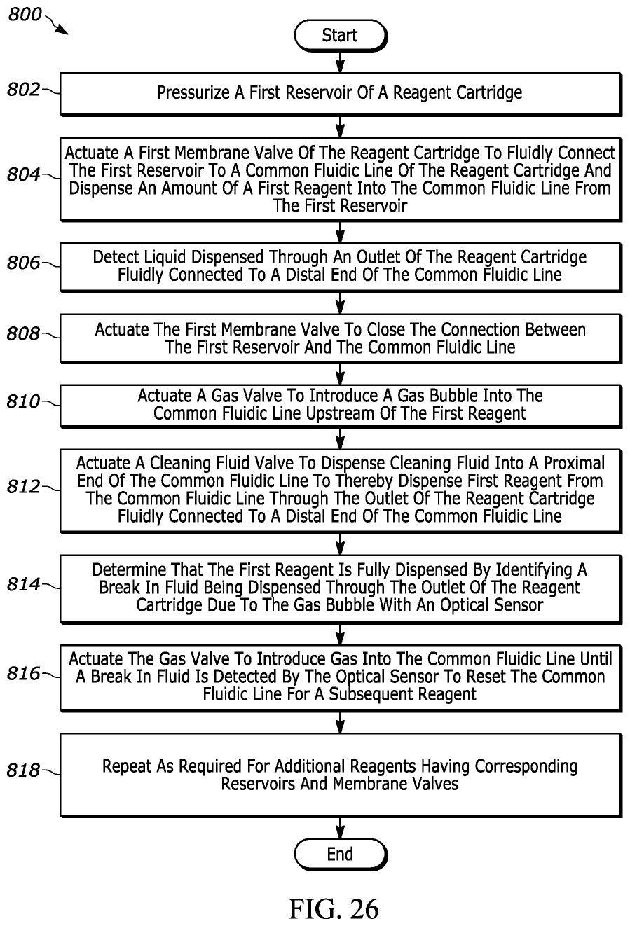

FIG. 26 illustrates a flowchart for a method of using the system 100 of FIG. 1 or any of the implementations disclosed. The order of execution of the blocks may be changed, and/or some of the blocks described may be changed, eliminated, combined and/or subdivided into multiple blocks.

The process 800 of FIG. 26 begins with a first reservoir of a reagent cartridge being pressurized (Block 802). The first reservoir and any other reservoirs of the reagent cartridge may be pressurized by supplying a positive pressure to the first reservoir and other reservoirs from pressure outlets of a reagent cartridge interface having a body defining a plenum therein when the reagent cartridge interface is mounted to the reagent cartridge. Reagent within the first reservoir may be rehydrated prior to pressurizing the first reservoir. An outlet valve fluidly connected to the outlet is closed to do so to prevent fluid flow therethrough and a first membrane valve is opened to fluidly connect the first reservoir to the common fluidic line. Rehydrating fluid may be dispensed into the proximal end of the common fluidic line and into the first reservoir through the first membrane valve to thereby rehydrate a reagent within the first reservoir. The rehydrating fluid and the reagent may be mixed by repeatedly cycling between a positive pressure source and a negative pressure source fluidly connected to the first reservoir through a mixing needle inserted therein. The rehydrating fluid and the reagent may be mixed in other ways, however.

A first membrane valve of the reagent cartridge is actuated to fluidly connect the first reservoir to a common fluidic line of the reagent cartridge and dispense an amount of a first reagent into the common fluidic line from the first reservoir (Block 804). Optionally, such as with a dry common line prior to dispensing of the first reagent, liquid being dispensed through the outlet of the reagent agent can be detected (Block 806). The first membrane valve is actuated to close the connection between the first reservoir and the common fluidic line (Block 808).

A gas valve is optionally actuated to introduce a gas bubble into the common fluidic line upstream of the first reagent (Block 810). A cleaning fluid valve is actuated to dispense cleaning fluid into a proximal end of the common fluidic line to thereby dispense the first reagent from the common fluidic line through the outlet of the reagent cartridge fluidly connected to a distal end of the common fluidic line (Block 812). Droplets of the first reagent can be dispensed by impacting an anvil at the distal end of the common fluidic line with a piezo hammer. The reagent may alternatively be dispensed using a metering device such as a rapidly acting valve or a positive displacement hammer. Other approaches may be suitable.

In the implementation utilizing the gas bubble of Block 810, the process 800 can optionally determine that the first reagent is fully dispensed by identifying a break in fluid being dispensed through the outlet of the reagent cartridge due to the gas bubble with an optical sensor (Block 814). Optionally, the gas valve can be actuated to introduce gas into the common line until a break in fluid is detected by the optical sensor to reset the common fluidic line for a subsequent reagent (Block 816).

Blocks 802-816 can be repeated as desired or required for additional reagents having corresponding reservoirs and membrane valves. In one implementation, this includes a second reservoir of the reagent cartridge is pressurized. A second membrane valve of the reagent cartridge is actuated to fluidly connect the second reservoir to the common fluidic line and dispense an amount of a second reagent into the common fluidic line from the second reservoir. The second membrane valve is actuated to close the connection between the second reservoir and the common fluidic line. The cleaning fluid valve is actuated to dispense cleaning fluid into the proximal end of the common fluidic line to thereby dispense the second reagent from the common fluidic line through the outlet of the reagent cartridge.

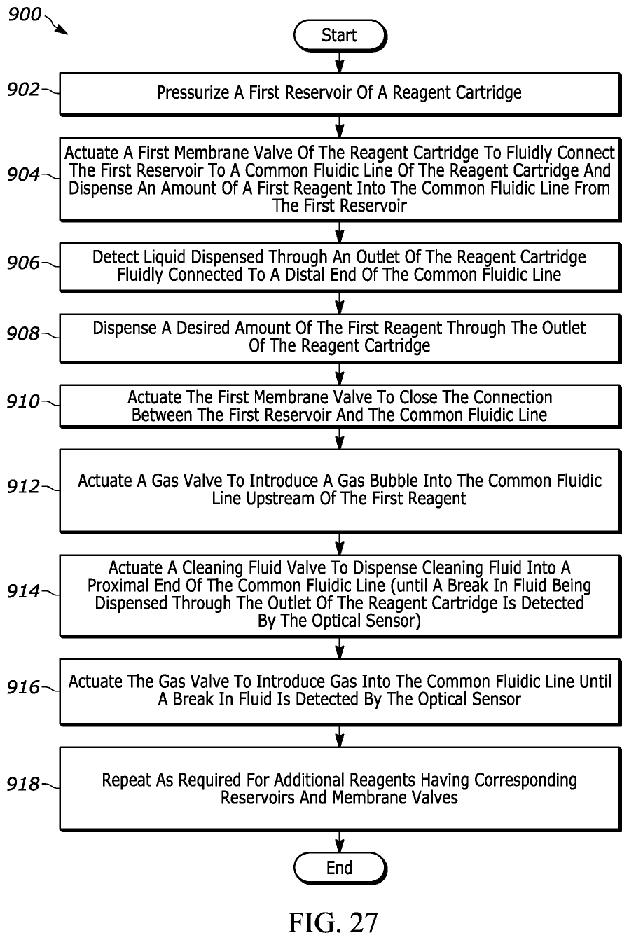

FIG. 27 illustrates a flowchart for a method of using the system 100 of FIG. 1 or any of the implementations disclosed. The order of execution of the blocks may be changed, and/or some of the blocks described may be changed, eliminated, combined and/or subdivided into multiple blocks.

The process 900 of FIG. 27 begins with a first reservoir of a reagent cartridge being pressurized (Block 902). The first reservoir and any other reservoirs of the reagent cartridge may be pressurized by supplying a positive pressure to the first reservoir and other reservoirs from pressure outlets of a reagent cartridge interface having a body defining a plenum therein when the reagent cartridge interface is mounted to the reagent cartridge. Reagent within the first reservoir may be rehydrated prior to pressurizing the first reservoir. An outlet valve fluidly connected to the outlet is closed to prevent fluid flow therethrough and a first membrane valve is opened to fluidly connect the first reservoir to the common fluidic line. Rehydrating fluid may be dispensed into the proximal end of the common fluidic line and into the first reservoir through the first membrane valve to thereby rehydrate a reagent within the first reservoir. The rehydrating fluid and the reagent may be mixed by repeatedly cycling between a positive pressure source and a negative pressure source fluidly connected to the first reservoir through a mixing needle inserted therein. The rehydrating fluid and the reagent may be mixed in other ways, however.

A first membrane valve of the reagent cartridge is actuated to fluidly connect the first reservoir to a common fluidic line of the reagent cartridge and dispense an amount of a first reagent into the common fluidic line from the first reservoir (Block 904). Optionally, such as with a dry common line prior to dispensing of the first reagent, liquid being dispensed through the outlet of the reagent agent can be detected (Block 906). A desired amount of the first reagent is dispensed through an outlet of the reagent cartridge fluidly connected to a distal end of the common fluidic line (Block 908). The first membrane valve is actuated to close the connection between the first reservoir and the common fluidic line (Block 910).

A gas valve is optionally actuated to introduce a gas bubble into the common fluidic line upstream of the first reagent (Block 912). A cleaning fluid valve is actuated to dispense cleaning fluid into a proximal end of the common fluidic line to thereby dispense the first reagent from the common fluidic line through the outlet of the reagent cartridge fluidly connected to a distal end of the common fluidic line (Block 914). Droplets of the first reagent can be dispensed by impacting an anvil at the distal end of the common fluidic line with a piezo hammer. The reagent may alternatively be dispensed at using a metering device such as a rapidly acting valve or a positive displacement hammer. Other approaches may be suitable.

In the implementation utilizing the gas bubble of Block 810, the process 800 can optionally determine that the first reagent is fully dispensed by identifying a break in fluid being dispensed through the outlet of the reagent cartridge due to the gas bubble with an optical sensor (Block 914). Optionally, the gas valve can be actuated to introduce gas into the common line until a break in fluid is detected by the optical sensor to reset the common fluidic line for a subsequent reagent (Block 916).

Blocks 902-916 can be repeated as desired or required for additional reagents having corresponding reservoirs and membrane valves. In one implementation, this includes a second reservoir of the reagent cartridge is pressurized. A second membrane valve of the reagent cartridge is actuated to fluidly connect the second reservoir to the common fluidic line and dispense an amount of a second reagent into the common fluidic line from the second reservoir. A desired amount of the second reagent is dispensed through the outlet of the reagent cartridge. The second membrane valve is actuated to close the connection between the second reservoir and the common fluidic line. The cleaning fluid valve is actuated to dispense cleaning fluid into the proximal end of the common fluidic line to thereby dispense the second reagent from the common fluidic line through the outlet of the reagent cartridge.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. An apparatus, comprising:
a reagent cartridge, comprising:
a body defining a plurality of reservoirs containing reagent, each reservoir having an outlet and a distal end defining an opening;
a manifold assembly, comprising:
an outlet;
a common fluidic line fluidly coupled to the outlet;
a plurality of reagent fluidic lines fluidly coupled to the corresponding outlet of the reservoirs; and
a plurality of membrane valves selectively actuatable to fluidly couple the common fluidic line and a corresponding one of the plurality of reagent fluidic lines and control a flow of the reagent therebetween,
a reagent cartridge receptacle to receive the reagent cartridge;
a pressure source;
a reagent cartridge interface having a pressure inlet fluidly coupled to the pressure source, and a mating surface defining pressure outlets fluidly coupled to the pressure inlet;
a plate receptacle to receive a plate having a well,
wherein the mating surface of the reagent cartridge interface mates with the distal ends of the reservoirs and the pressure source pressurizes the corresponding reservoirs and wherein a non-contact dispenser assembly comprises the reagent cartridge, the reagent cartridge receptacle, and the reagent cartridge interface and is to dispense the reagent into the well of the plate.

2. The apparatus of claim 1, further comprising a cleaning fluid reservoir; and wherein the reagent cartridge comprises a cleaning fluid port fluidly coupled to the cleaning fluid reservoir and the common fluidic line and wherein the reagent cartridge interface comprises a cleaning fluid conduit having a first end fluidly coupled with the cleaning fluid reservoir and a second end fluidly coupled with the cleaning fluid port of the reagent cartridge and an outlet conduit having a first end fluidly coupled with the outlet of the reagent cartridge.

3. (canceled)

4. The apparatus of claim 1, wherein the reagent cartridge interface comprises a plenum fluidly coupled with the pressure inlet and the pressure outlets.

5. The apparatus of claim 1, wherein the outlet of the reagent cartridge comprises an outlet port; and the reagent cartridge interface comprises an outlet conduit having a first end fluidly coupled with the outlet port of the reagent cartridge and a second end through which the reagent is dispensed.

6-12. (canceled)

13. The apparatus of claim 1, further comprising a temperature controller adjacent the reagent cartridge receptacle and positioned to control a temperature of the reagent cartridge.

14. (canceled)

15. The apparatus of claim 1, further comprising an actuator assembly to selectively actuate the membrane valves.

16. The apparatus of claim 15, wherein the actuator assembly comprises a housing defining a mouth that receives a portion of the manifold assembly comprising the membrane valves.

17. The apparatus of claim 16, wherein the reagent cartridge comprises opposing first and second membranes coupled to the body thereof; and each of the membrane valves has a valve seat and a valve member positioned between the opposing first and second membranes, at least one of the valve members being a cantilever having a distal end that is adapted to move the first membrane away from the corresponding valve seat of one of the plurality of membrane valves.

18. The apparatus of claim 17, wherein an actuator of the actuator assembly is to interface with both of the first and second membranes for a corresponding one of the plurality of membrane valves.

19. The apparatus of claim 18, wherein the actuator comprises C-shaped members having an opening in which the portion of the manifold assembly is positioned.

20. The apparatus of claim 19, further comprising springs carried by the housing of the actuator assembly, each of the C-shaped members having a first leg and a second leg, the first leg to urge the first membrane into engagement with the corresponding valve seat, the second leg to urge the distal end of the cantilever into engagement with the first membrane to move the first membrane away from the corresponding valve seat.

21. The apparatus of claim 20, wherein the actuator of the system comprises an indexed rod to move the first leg of the C-shaped member away from the valve seat and to move the second leg of the C-shaped member to urge the distal end of the cantilever into engagement with the first membrane to move the first membrane away from the corresponding valve seat.

22. The apparatus of claim 1, further comprising a plurality of actuators carried by the reagent cartridge interface, wherein each actuator of the plurality of actuators corresponds to one of the plurality of membrane valves and is actuatable to selectively control a flow of reagent between each of the reagent fluidic lines and the common fluidic line.

23. (canceled)

24. The apparatus of claim 1, wherein the reagent cartridge comprises a secondary reagent reservoir, a secondary fluidic line, and a secondary outlet fluidly coupled to the secondary reagent reservoir by the secondary fluidic line.

25. The apparatus of claim 24, wherein the secondary outlet comprises a secondary outlet port; and the reagent cartridge interface comprises a conduit having a first end fluidly coupled with the secondary outlet port and a second end through which reagent contained within the second reagent reservoir is dispensed.

26. The apparatus of claim 1,
wherein the pressure inlet comprises a first pressure inlet and a second pressure inlet and the pressure outlets comprise a first pressure outlet and a second pressure outlet, the first pressure inlet fluidly coupled to the first pressure outlet and the second pressure inlet fluidly coupled to the second pressure outlet.

27-28. (canceled)

29. An apparatus, comprising:
a reagent cartridge comprising:
a body defining a plurality of reservoirs, each reservoir having an outlet and a distal end defining an opening;
a manifold assembly, comprising:
an outlet;
a common fluidic line fluidly coupled to the outlet;
a plurality of reagent fluidic lines coupled to the corresponding outlet of the reservoirs; and
a plurality of membrane valves selectively fluidly coupling the common fluidic line and a corresponding one of the plurality of reagent fluidic lines.

30-33. (canceled)

34. The apparatus of claim 29, wherein the reagent cartridge comprises opposing membranes coupled to the body thereof, the body defining a portion of the common fluidic line, a portion of the plurality of reagent fluidic lines, and a plurality of valve seats that each separate the common fluidic line and a corresponding one of the plurality of reagent fluidic lines.

35. The apparatus of claim 34, wherein the plurality of membrane valves further comprise a valve member, the valve member movable to selectively fluidly couple the common fluidic line and a corresponding one of the plurality of reagent fluidic lines responsive to actuation thereof.

36. The apparatus of claim 35, wherein at least one of the valve members is a cantilever having a distal end that is adapted to move one of the opposing membranes away from a corresponding valve seat of one of the plurality of membrane valves.

37. The apparatus of claim 35, wherein the valve members are positioned between the opposing membranes.

38. The apparatus of claim 29, further comprising a valve positioned between the outlet and the membrane valves and to control a flow of the reagent out of the outlet.

39-50. (canceled)
